(19) United States
(12) Patent Application Publication
(10) Pub. No.: US 2026/0196103 A1
(43) Pub. Date: Jul. 9, 2026

(54) Devices, Systems and Processes for Facilitating User Participation in Multi-Jackpot Games

(71) Applicant: DK Crown Holdings Inc., Boston, MA (US)

(72) Inventors: Jason Robert March, Las Vegas, NV (US); Jeffrey Williams, Sandwich, MA (US); Cynthia Farruggia, Brockton, MA (US); Joseph Michael Nissim Behar, San Francisco, CA (US); Yom F Woldemichael, Schuyler Lake, NY (US); Joseph Roland Beaulieu, Harvard, MA (US); Michael James Powell, Phoenixville, PA (US); Daniel Sun, Marion, IA (US); Gary J Springer, JR., Bend, OR (US); Hagar Raban, Ramat Gan (IL); James Brian Scroggins, JR., Henderson, NV (US); Trey Alexander Giacomodonato, Las Vegas, NV (US); Amir Askarov, Rehovot (IL)

(73) Assignee: DK Crown Holdings Inc., Boston, MA (US)

(21) Appl. No.: 19/416,807

(22) Filed: Dec. 11, 2025

Related U.S. Application Data
(60) Provisional application No. 63/742,133, filed on Jan. 6, 2025.
(60) Provisional application No. 63/742,145, filed on Jan. 6, 2025.

(51) Int. Cl. G07F 17/32

(52) U.S. Cl. CPC G07F 17/3258

(57) ABSTRACT

Device, systems, processes and computer readable medium facilitate user participation in multi-jackpot games. A system includes a player device which instantiates a lobby engine that configures the player device to receive a first identification of at least two available online casino games (OCGs); receive a second identification of at least two available jackpots; and present the at least two available OCGs and the at least two available jackpots to a player. A player interface service (PIS), coupled to the player device, facilitates player participation in a given selected OCG and at least one selected jackpot. A jackpot gamification service (JGS) instantiates a gaming engine for the at least one selected jackpot. Based on a current location of the player device a third identification of at least two location specific OCGs and at least two location specific jackpots available to the given player are provided.

### CROSS-REFERENCE TO RELATED APPLICATIONS

The present application claims priority to U.S. Provisional Patent Application Ser. No. 63/742,145, filed on 6 Jan. 2025, in the name of inventors Jeffrey Williams et. al., entitled “Devices, Processes and Systems for Facilitating Multi-Jackpot Games,” and further identified by the attorney docket number DK20241207 (DK-00016) (herein, the “DK16 App.”).

The present application claims priority to U.S. Provisional Patent Application Ser. No. 63/742,133, filed on 6 Jan. 2025, in the name of inventors Joseph Roland Beaulieu et. al., entitled “Devices, Processes and Systems for Facilitating Multi-Jackpot Games,” and further identified by the attorney docket number DK20241206 (DK-00015) (herein, the “DK15 App.”).

The present application is related to U.S. patent application Ser. No. 19/416,410, filed on 11 Dec. 2025, in the name of inventors Joseph Roland Beaulieu et. al., entitled “Devices, Processes and Systems for Facilitating Multi-Jackpot Games,” and further identified by the attorney docket number DK20241206.1 (DK-00025) (herein, the “DK25 App.”).

The entire contents of the DK15 App., the DK16 App., and the DK25 App. are herein incorporated by reference.

### TECHNICAL FIELD

The technology described herein generally relates to devices, systems, and processes for facilitating user participation in multi-jackpot games.

### BACKGROUND

An online casino gaming system (“OCGS”) commonly includes a player device, by which a user (which is also referred to herein as a “player”) receives data regarding one or more online casino style games, makes bets, engages with the game (e.g., by spinning a slot, taking a card, depositing or withdrawing funds, or the like). The player device commonly utilizes one or more application program interfaces, applications, web pages, or the like (herein collectively, “APIs”) that facilitate the “game play” on their chosen player device, with non-limiting examples of player devices including smartphones, tablet computing devices, laptop computers, desktop computers, and the like. The API communicates, with various servers, data regarding casino game selection, wager amount, the player's bet selections (e.g., raise, hold, double down, or the like), the player's “game play” activities (e.g., draw a card, hold, split cards, spin a slot machine wheel, or the like), results of “game play” (e.g., win, lose, etc.), and the like.

The various servers may include “casino game play” servers (which are also referred to herein as “aggregators”), OCGS provider servers and the like. One non-limiting example of an aggregator is International Game Technology (IGT™) based in Reno, Nevada, USA. One non-limiting example of an OCGS provider is DraftKings Inc. of Boston Massachusetts, USA. Aggregators commonly utilize servers, data stores, and the like, which may be Cloud based, or otherwise provided, to facilitate the gaming related aspects of a given online casino game (e.g., the providing of a virtual deck of cards for a blackjack game, the shuffling of the cards, drawing of cards, etc.). Each of such gaming related aspects are referred to herein as each being the providing of a “casino game service” and are typically highly regulated by various governmental entities. The features and functions provided by a given aggregator for any given casino game service are beyond the scope of the present disclosure and any aggregator and/or online casino game may be utilized in conjunction with an implementation of the present disclosure.

As is well known, an OCGS provider commonly provides its online casino gaming services by leveraging, in conjunction with the services provided by one or more aggregators, the distributing data processing, storage, communications and other features of Cloud (as defined herein) providers, such as Amazon Web Services (AWS™). It is to be appreciated that Cloud services commonly utilized multiple servers, data stores, couplings, communications networks, security modules, and the like (as respectively defined hereinbelow and as otherwise collectively referred to herein as “OCGS service” and/or a “provider service”). Utilizing OCGS services, an OCGS provider provides one or more services that facilitate various non-gameplay related activities, such as user verification, game play interfaces, lobby functions, wager, account processing, and the like.

Often, a given online casino game may be associated, by an OCGS provider, with a jackpot. For example, an online casino game, such as HYPER NOVA™, may include game play that is supported by an aggregator and a jackpot that is provided by an OCGS provider, such as DraftKings Inc, under the DRAFTKINGS™ brand. The jackpot enable a player of a given online casino game to seek to receive winnings (i.e., jackpots) greater than a successful single play of the given online casino game would otherwise commonly award. The jackpot may apply across many games and may increase as multiple participants wager bets thereagainst. Numerous types of jackpots may be provided by an OCGS service. For example, and not by limitation, featured jackpots, daily must drop jackpots, must hit by jackpots, multi-level jackpots, single-level jackpots, slot jackpots, table game jackpots, live dealer jackpots, and the like may be provided, at any given time, by an OCGS service. However, today, a player may only select to play, at any given time, and while participating in a given online casino game (e.g., blackjack), a single one of the multitude of jackpots available. In essence the player is technologically prohibited today from participating in multiple, distinct jackpots in association with the playing of a given online casino game. These technological prohibitions arise due to technical complexities arising from various factors including, for example, the number of OCGs available, the number of jackpots that can be associated with a given OCG, the fact that a given jackpot may be associated with multiple OCGs, the fact that numerous (often thousands) of players may be participating in a given OCG and/or a given jackpot, at a given time, the fact that a given participant may desire to participate in one or more jackpots associated with a given OCG, at a given time, while desiring at a later time (which may occur substantially immediately after a current time) to switch their participation to another OCG and/or another jackpot, let alone one or more multiple other jackpots.

Accordingly, devices, systems and processes are needed that facilitate user participation in multi-jackpot games in the OCGS environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

Various implementations are described of devices, systems, and processes for generating fixture specific models and utilizing such fixture specific models during real-time event simulations to generate real-time pricing for one or more betting lines where the real-time pricing accounts for one or more real-time variations in one or more fixtures for the event.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

In accordance with at least one implementation of the present disclosure, a system, facilitating user participation in multi-jackpot games, may include a player device, wherein a given player is currently associated with the player device. The player device may include: a player device processor; a player device user interface including a display element; and a non-transitory player device data store non-transitorily storing: first computer instructions which, when executed by the player device processor, instantiate a lobby engine that configures the player device to perform lobby operations including: receiving a first identification of at least two available online casino games (OCGs) for the given player; receiving a second identification of at least two available jackpots; and presenting to the given player, via the display element, the at least two available OCGs and the at least two available jackpots. The system may also include a player interface service (PIS), coupled to the player device, facilitating participation by the given player in: a given selected OCG. The given selected OCG may be determined based on a selection, received from the given player and via the player device, of one of the at least two available OCGs and at least one selected jackpot. The at least one selected jackpots may be determined based on a selection, received from the player device, of at least one of the at least two available jackpots. The system may also include a jackpot gamification service (JGS) coupled to the player device and the PIS. The JGS may be configured to instantiate respective gaming engines for the at least one selected jackpot.

For at least one implementation, the lobby operations may include: determining a current location of the player device; reporting the current location to the PIS; receiving from the PIS a third identification of at least two location specific OCGs available to the given player; and receiving from the PIS a fourth identification of at least two location specific jackpots available to the given player. The PIS may generate the third identification of at least two location specific OCGs available to the given player based on the current location of the player device. The PIS may generate the fourth identification of the at least two location specific jackpots available to the given player based on the current location of the player device.

For at least one implementation, the lobby operations may further include: determining a current time for the player device; reporting the current time to the PIS; receiving from the PIS a second identification of at least two time specific OCGs available to the player device; and receiving from the PIS a second identification of the at least two time specific jackpots available to the player device.

For at least one implementation, the lobby operations may further include: querying an online casino gaming aggregator service for an identification of at least two OCGs available to the player device based on at least one of a current time and a current location of the player device.

For at least one implementation, the lobby operations further include: receiving gameplay data, for the given player, from an account management system (AMS); and communicating the gameplay data to the PIS. The first identification of at least two available online casino games (OCGs) for the given player may be determined, by the PIS, based on the gameplay data for the given player.

For at least one implementation, the presenting of the at least two available OCGs and the at least two available jackpots to the given player may include: generating, on a graphical user interface (GUI) instantiated by the player device user interface, one or more windows including: an informational window providing data regarding given player participation options in the at least two available online casino games and the at least two available jackpots; an OCG window presenting the at least two available online casino games; and a jackpots window presenting the at least two available jackpots.

For at least one implementation, the non-transitory player device data store may further non-transitorily store: second computer instructions which, when executed by the player device processor, instantiate a player device OCG engine (PDOCGE) that configures the player device to perform OCG operations (OCGOps) including: receiving the selection, by the given player, of the given selected OCG; launching an OCG module for the given selected OCG; and communicating gameplay data, for the given selected OCG, with an online casino gaming aggregator service (OCGAS).

For at least one implementation, the non-transitory player device data store may further non-transitorily store: third computer instructions which, when executed by the player device processor, instantiate player device multi-jackpot gaming engine (PDMJGE) that configures the player device to perform multi-jackpot gaming operations (MJGOps) including: launch operations including: querying a jackpot data service (JDS) for the second identification, for the at least two available OCGs, of at least two available jackpots; an subscribing to a message stream providing data regarding one or more of the at least one selected jackpot.

For at least one implementation, the launch operations may include: activating a bubble module (BubbleM) that configures the player device to generate one or more graphical user interface (GUI) elements that signal to the given player that at least one of the at least two available jackpots is: available for selection by the given player; the at least one selected jackpot; or an unavailable jackpot.

For at least one implementation, the BubbleM may signal to the given player that the at least one selected jackpot is an opted-in jackpot in which the given player participates by default.

For at least one implementation, a jackpot specific wager is not paid in order for the given player to participate in the opted-in jackpot.

For at least one implementation, the BubbleM may signal to the given player and with respect to at least one of the at least two available jackpots: a selection status; a reward amount; and a current wager amount.

For at least one implementation, the one or more GUI elements generated by the BubbleM may include a collection of at least two overlay buttons, including a separate overlay button for each of the at least two available jackpots.

For at least one implementation, at least one of the collection of at least two overlay buttons may float over an actionable item presented on the display element of the player device.

For at least one implementation, the collection of at least two overlays may include a total jackpots overlay button.

For at least one implementation, the total jackpots overlay button may include: a first field indicating a number of selected jackpots in which the given player is currently participating; a second field indicating a participation wager for the at least one selected jackpot; and a third field providing a graphical image that is uniquely associated with the total jackpots overlay button.

For at least one implementation, upon a selection by the given player of the total jackpots overlay button, the BubbleM generates a second GUI element identifying at least two of the at least two available jackpots and the at least one selected jackpot.

For at least one implementation, the second GUI element may be presented, by the display element, at least one of horizontally or vertically and across at least a portion of the display element and super-imposed upon the at least two OCGs presented on the display element.

For at least one implementation, the lobby operations may include: generating a jackpot buttons bar including two or more jackpot buttons; and presenting the jackpot buttons bar on the display element. The jackpots button bar may respectively identify, in a given one of the two or more jackpot buttons, the at least two available jackpots and the at least one selected jackpot.

For at least one implementation, the least two available jackpots and the at least one selected jackpot may be presented, in the jackpots button bar, as separate buttons that respectively identify a selection status, a reward amount, and a current wager amount.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1A is a schematic illustration of a Multi-Jackpot Game (MJG) System (MJGS) in accordance with at least one implementation of the present disclosure.

FIG. 1B is a schematic of a Player Device (PD) as utilized in the MJGS of FIG. 1A and in accordance with at least one implementation of the present disclosure.

FIG. 2 is a schematic of a player interface service (PIS) as utilized in the MJGS of FIG. 1A, as further described in the DK15 App., and in accordance with at least one implementation of the present disclosure.

FIG. 3 is a schematic of a casino gaming aggregator service (CGAS) as utilized in utilized in the MJGS of FIG. 1A, as further described in the DK15 App., and in accordance with at least one implementation of the present disclosure.

FIG. 4 is a schematic of a user management service (UMS) as utilized in utilized in the MJGS of FIG. 1A, as further described in the DK15 App., and in accordance with at least one implementation of the present disclosure.

FIG. 5 is a schematic of a jackpot gamification service (JMS) as utilized in utilized in the MJGS of FIG. 1A, as further described in the DK15 App., and in accordance with at least one implementation of the present disclosure.

FIG. 6 is a schematic of an OCG and Jackpot transaction service (OCGJTS) as utilized in utilized in the MJGS of FIG. 1A, as further described in the DK15 App., and in accordance with at least one implementation of the present disclosure.

FIG. 7 is a schematic of an account management service (AMS) as utilized in utilized in the MJGS of FIG. 1A, as further described in the DK15 App., and in accordance with at least one implementation of the present disclosure.

FIG. 8 is a process diagram illustrating various operations performed by the components of the MJGS of FIG. 1A, as further described in the DK15 App., and in accordance with at least one implementation of the present disclosure.

FIGS. 9A-9E illustrate a first set of screen displays for a web gaming application, generated as a graphical user interface on the player device of FIG. 1B, configured to facilitate player participation in an MJG, and in accordance with at least implementation of the present disclosure.

FIGS. 10A-10F illustrate a second set of screen displays for a mobile application, generated as a graphical user interface on the player device of FIG. 1B, configured to facilitate player participation in an MJG, and in accordance with at least implementation of the present disclosure.

### DETAILED DESCRIPTION

Various implementations of the present disclosure describe devices, systems and processes for providing multi-game jackpot (MJGP) in an OCGS.

As used herein:
“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.
“Application” herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately.
“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.
“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.
“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating pricing of betting lines which account for changes in probabilities occurring due to fixture variations during an event. An implementation may utilize Cloud resources using any known or later arising data delivery, processing, storage, virtualization, or otherwise technologies, standards, protocols, or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazon.com Inc., AZURE provided by Microsoft Corp., and others.
“Component” herein refers to a Module of a Device, as further defined herein.
“Computer Data” herein refers to a form Data, as further defined herein, configured for use by one or more processors in a device such as a computer and/or a server.
“Computer engine” (or “engine”) herein refers to a combination of a processor and non-transitory computer instruction(s). A computer engine executes computer instructions to perform one or more logical operations (herein, a “logic”) which facilitate various actual (non-logical) and tangible features and function provided by a system, a device, and/or combinations thereof.
“Computer instruction” herein refers to an Instruction, as further defined herein.
“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.
“Content” herein refers to data that that may be presented, using a suitable presentation device, to a user in a humanly perceptible format. When presented to a human, the data becomes “information.” Non-limiting examples of content include gaming images and graphics such as those related to bet placement, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized.
“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Field Networks (WAN), such as the Internet, Local Field Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling. A coupling may be “direct”, which herein means that a communication path between two system components does not utilize another, intermediary system component, and/or “indirect” meaning that a communications path between two or more system components may utilize one or more intermediary system components for such communications.
“Data” (which is also referred to herein as a “computer data”) herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, transitory and/or non-transitory form, as determined by any given state of such data, at any given time. For a non-limiting example, a given data packet may be non-transitory while stored in a storage device, but transient during communication of the given data packet from a first device or system to a second (or more) device or system. When received and stored in memory, data storage device, or otherwise, the given data packet has a non-transitory state. For example, and not by limitation, data may take any form including as one or more applications, content, or otherwise. Instructions, as further described herein, are a form of data.
“Data store” herein refers to any device or combinations of devices configured to store data on a temporary, permanent, non-transitory, or other basis. A data store is also referred to herein as a “computer readable medium.” A data store may store data in any form, such as electrically, magnetically, physically, optically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transitory data, non-transitory computer instructions, or other the like may be suitably stored in a data store. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient or transitory storage of data. Permanent storage and/or temporary storage may be used to store transitory and non-transitory data with the data, while stored, being herein deemed to be non-transitory data.
“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.
“Instruction” (which is also referred to herein as a “computer instruction”) herein refers to a non-transitory processor executable instruction, associated data structures, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the data for one or more instructions is being utilized, such use is herein deemed to occur on a non-transient and non-transitory basis.
“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, applications, modules, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other hosts on an as-needed basis, or otherwise. Any known or later arising technologies may be used to provide a given module and the features and functions supported therein.
“Player Device” herein refers to a device configured for use by a human being to one or more of communicate, present, process, and store data. Non-limiting examples of player devices include smartphones, laptop computers, tablet computing devices, desktop computers, smart televisions, smart glasses, virtual reality glasses, augmented reality glasses, earbuds/headphones and other audible output devices, and other devices.
“Power Supply/Power” herein refers to any known or later arising technologies which facilitate the use of electrical energy by a device. Non-limiting examples of such technologies include batteries, power converters, inductive charging components, line-power components, solar power components, and otherwise.
“Processor” herein refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, Cloud based, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded and otherwise.
“Security Component/Security Module/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), and transport security standards, such as Transport Layer Security (TLS) or Secure Sockets Layer (SSL).
“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data, using a network or otherwise, directly or indirectly, to another device, to another server, or otherwise.
“Service” herein refers to and, when claimed, recites definite structure for one or more singular or when combined (logically, physically, virtually, or otherwise) electrical/electronic device(s) that are configured to provide at least one feature and/or output signal and/or perform at least one function including the features, output signals and functions described herein. A service may provide the one or more functions using computer engines, processors, computer instructions and the like. A service may be Cloud or otherwise based. When a feature, output signal and/or function is provided, in whole or in part, using a processor, one more software components may be used, and a given service may include a processor configured to execute computer instructions. A person having ordinary skill in the art (a “PHOSITA”) will appreciate that the specific hardware and/or computer instructions used for a given implementation will depend upon the functions to be accomplished by a given service. Likewise, a PHOSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.
“Substantially simultaneous(ly)” herein refers to an absence of a greater than expected and humanly perceptible delay between a first event or condition, such as a completion of an activity, and a second event or condition, such as a placing of a bet for a given activity where one or more betting lines have been modified in view of a currently occurring fixture. Substantial simultaneity may vary in a range of quickest to slowest expected delay, to a moderate delay, or to a longer delay. For at least one implementation, substantial simultaneity occurs within an acceptable delay (as described above).
“User” and “Player” herein refers to a single person and/or a group of users who are being presented, via a suitable user device, with a given content, at a given time.
“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, expanded reality glasses, earbuds/headphones and other audible output devices, and other devices.
“User Interface” herein refers to one more components, provided with or coupled to a device configured to receive information from and/or present information to a user, a player or the like. A user interface may include one more Additional I/O interfaces, Audio I/O interfaces, and Visual I/O interfaces.
“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Multi-Jackpot Game System (MJGS) 100

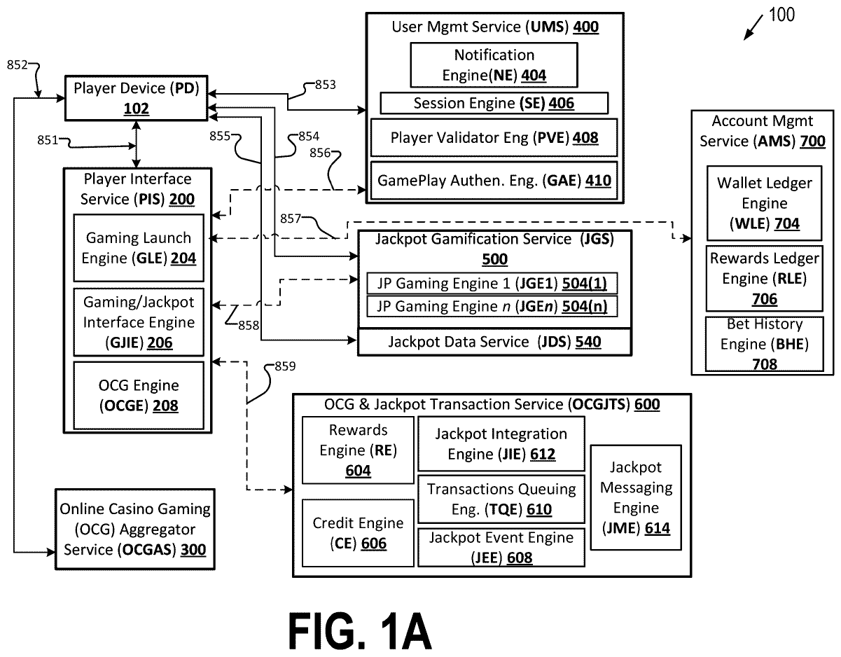

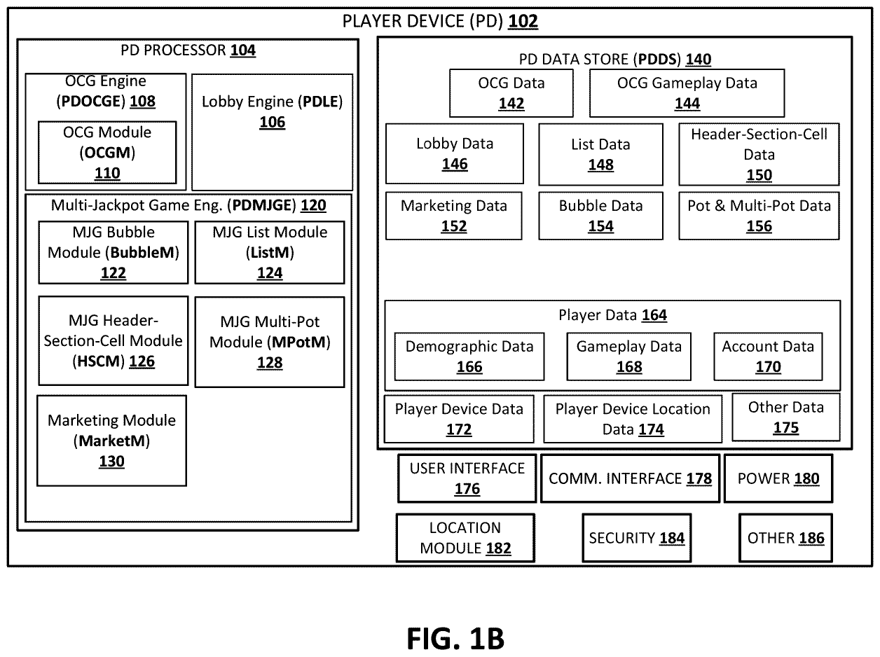

As shown in FIG. 1A and for at least one implementation of the present disclosure, an MJGS 100, may include: at least one player device 102; at least one player interface service (PIS) 200; at least one online casino gaming aggregator service (OCGAS) 300; at least one user management service (UMS) 400; at least one jackpot gamification service (JGS) 500; at least one OCG and jackpot transaction service (OCGJTS) 600; and at least one account management service (AMS) 700. For at least one implementation “n” instances (where, “n” is an integer) of the player device 102, the PIS 200, the OCGAS 300, the UMS 400, the JGS 500, the OCGJTS 600 and/or the AMS 700 may be utilized in a given implementation of the present disclosure. Other known and/or later arising services which facilitate multi-jackpot games may also and/or alternatively be used in other implementations of the present disclosure. As shown in FIGS. 1A, and 2-7, each of the PD 102, the PIS 200, the OCGAS 300, the UMS 400, the JGS 500, the OCGJTS 600, and the AMS 700 may include and/or have access to: at least one user interface, as defined herein, including user interfaces 176, 230, 330, 430, 530, 630, and 730; at least one communications interface, as defined herein, including communications interfaces 178, 232, 332, 432, 532, 632, and 732; at least one power, as defined herein, including power 180, 234, 334, 434, 535, 634 and 734; at least one security, as defined herein, including security 184, 236, 336, 436, 536, 636 and 736; and at least one “other” module, include other modules 186, 238, 338, 438, 538, 638 and 738. As shown, the various elements of the MJGS may be suitably coupled by a fifty-first coupling 851 through a sixty-third coupling 863. Additional, lesser and/or alternative couplings may be utilized in other implementations of the present disclosure including the first through thirty seventh (801-837) couplings described in the DK15 App.—such couplings being incorporated herein by reference. One or more of such couplings may be configured as providing simplex, duplex or other data flows, with all such couplings being shown herein as duplex for purposes of illustration.

### Player Device (PD) 102

As shown in FIGS. 1A and 1B, and in accordance with at least one implementation, the PD 102 may include a PD processor 104 configured to execute non-transitory computer instructions which instantiate one more computer engines including an OCG engine (PDOCGE) 108, a lobby engine (PDLE) 106, and an MJG engine (PDMJGE) 120. The computer engines may further utilize one or more modules which facilitate the presentation of OCGs and MJGs to a player and participation by the player therein using a PD 102 associated with the player. These computer engines and modules are further described hereinbelow.

The PD 102 also may include a non-transitory PD data store (PDDS) 140 configured to non-transitorily store the computer instructions for the PDOCGE 108, the PDLE 106, the PDMJGE 120 and the various modules utilized thereby, and other data. The PDDS 140 may be configured to non-transitorily store such data in one or more data storage files, folders, locations, or other logical containers including one or more of the following categorizations of data: OCG data 142, OCG gameplay data 144, Lobby data 146, List data 148, Header-Section-Cell data 150, Marketing data 152, bubble data 154, and Pot & Multi-pot data 156.

As shown in FIG. 1A and for at least one implementation, the PD 102 may be directly coupled to the PIS 200 (via, e.g., a fifty-first coupling 851), the OCGAS 300 (via, e.g., a fifty-second coupling 852), the UMS 400 (via, e.g., a fifty-third coupling 853), to the JGS (via, e.g., a fifty-fourth coupling 854), and to the JDS 540 (via e.g., the fifty-fifth coupling 855). In FIG. 1A, a solid line is used to indicate a direct coupling, and a dashed line is used to indicate an indirect coupling between the PD 102 and another MJGS 100 components. As shown in FIG. 1A, a fifty-sixth coupling 856 may indirectly couple the PD 102 to the UMS (via the PIS 200), a fifty-seventh coupling 857 may indirectly couple the PD 102 with the AMS 700 (via the PIS 200), a fifty-eight coupling 858 may indirectly couple the PD 102 with the JGS 500 (via the PIS 200), and a fifty-ninth coupling 859 may indirectly couple the PD 102 with the OCGJTS 600 (via the PIS 200). Other couplings between the various components of the MJGS 100 are described in the DK15 App and are incorporated herein by reference.

For at least one implementation, a PD 102 may include a PD location module 182. The PD location module 182 may utilize any known and existing and/or later arising technologies which facilitate location determination of a given device with non-limiting examples including use of a Global Positioning System receiver and processor. The P20D location module 182 may be configured to determine and identify a current location of a given PD 102 to one or more of the PDOCGE 108, the PDLE 106 and the PDMJGE 120. The current location of the given PD 102 may be associated with a current player that has logged-in or otherwise gained access to the MJG features and functions provided by the given PD 102.

### Lobby Engine (PDLE) 106

For at least one implementation, PDDS 140 may include first computer instructions (1PDCI) that when executed by the PDP 104 instantiate the PDLE 106. The PDLE 106 configures the PD 102 to perform one or more Lobby operations (LobbyOps). The LobbyOps may include communicating data to/from the PIS 200. Such data assist the PD 102 in organizing and presenting data (in a “lobby” of information) on a screen display provided by the PD's user interface 176. As used herein, a “lobby” is a collection of data, presented as information by a user interface for a given PD 102, providing two or more OCG options available to a player, at a given time and at a given, current location. The lobby may present such collection of data visually and/or audibly. The lobby may also present one or more icons, buttons, or other user interface elements that identify one or more jackpots that may be available, at a given current time, to the given player, via the given PD 102.

To determine what data to present on a given lobby, the LobbyOps may include determining a current location for the given PD 102. It is to be appreciated that a current location of a given PD 102, and thereby a given player utilizing the given PD 102, may limit OCG and/or jackpot options available for the given player in view of one or more governmental, location, and/or other rules and/or regulations. The LobbyOps may include reporting the current location of the given PD 102 to the PIS 200 to facilitate an identification of OCG and jackpot options available at the given, current location, to the given player via the given PD 102.

One or more OCG and/or jackpot options available to a given player and/or via a given PD 102 may vary based on device type, time of day, location, in view of regulatory, contractual and/or other requirements, and the like. For at least one implementation, the LobbyOps may be configured as a gateway which determines which OCGs and/or jackpots are to be presented to a given player at a given current time. In so determining, the LobbyOps may (directly and/or indirectly) query one or more of the OCGAS 300, the UMS 400, and the AMS 700 to obtain data regarding which OCGs and/or jackpots are available for a given player at a given current time, place or otherwise.

For at least one implementation, the LobbyOps may be configured to determine one or more OCGs and/or jackpots that will be available to the given player at a later time, place, or otherwise. For at least one implementation, the LobbyOps may be configured to identify certain conditions a given player may need to satisfy to participate in a given OCG and/or one or more given jackpots. A non-limiting example of such conditions may include an account condition, e.g., providing sufficient reserve funds to participate in a given OCG or jackpot. Another non-limiting example of such a condition may include a player validation condition. For example, the LobbyOps may further include determining an identify of the player currently utilizing the PD 102. Such identification may include the use of one or more player identifiers, as provided by the player to the PD 102. Non-limiting examples of such identifiers include sign-on, password, and the like. One or more biometric identifiers, such as fingerprint, facial recognition, voice recognition, and the like may be used, in whole or in part, to identify the player.

For at least one implementation, the LobbyOps may include requesting, receiving and collecting given player identifying information. Non-limiting examples of such information may include, for a new or existing player, one or more demographics of a given player currently accessing the PD 102 may be determined. For at least one implementation, the PDLE 106 may determine such demographics by accessing player data 164 previously loaded into the PDDS 140. For at least one implementation, the player data 164 may include: demographic data 166 with non-limiting examples including the player's name, age, residence information, citizenship, and the like; player device data 172; player device location data 174, and other data 175.

For at least one implementation, the LobbyOps may include obtaining gameplay data 168, wherein gameplay data 168 indicates a given player's past gaming experiences, including games played, wins, losses, and the like. For at least one implementation, the LobbyOps may obtain gameplay data from the PDDS 140 and/or from the AMS 700. For at least one implementation, the LobbyOps may utilize direct and/or indirect couplings to a bet history engine (BHE) 708, which for at least one implementation is provided with the AMS 700.

For at least one implementation, the LobbyOps may include obtaining, for a given player, account data 170 from the PDDS 140 and/or from a wallet ledger engine (WLE) 704—as provided, e.g., by the AMS 700. Non-limiting examples of account data including data regarding banking, credit, crypto, PAYPAL, VENMO, ZELLE and other forms of financial instruments available to the given player. The account data 170 may include other forms of financial data for the given player including credits, debits, rewards earned, rewards available, rewards redeemed, available funds for gambling, and the like. Such account data may be specific to a provider of the MJGS 100. The account data 170 may include available/additional funds the player will designated/has designated as being available for gaming participation. The making of such funds available may use any known or later arising devices, processes, systems and the like with one non-limiting example being a placing of a reserve on a credit or debit card account associated with another financial institution.

For at least one implementation, the LobbyOps may not include communicating demographic data 166, gameplay data 168 and/or account data 170 by the PD 102 to/from the PIS 200. When communicating one or more instances of such data, an identification of the player may be provided, and any demographic, gameplay and/or account data needed to identify data to be used to populate a lobby may be obtained from other sources including but not limited to data stores provided by and/or accessible to the MJGS 100. Such data stores may include those provided by one or more of the PIS 200, the OCGAS 300, the UMS 400, the JGS 500, the OCGJTS 600, and the AMS 700. For at least one implementation, the PD 102 may be coupled to the PIS 200 via the fifty-first coupling 851. As shown in FIG. 1A and for at least one implementation, the PD 102 may be coupled to the OCGAS 300 via the fifty-second coupling 852. The respective security modules may be utilized to protect data communicated amongst the various MJGS 100 components.

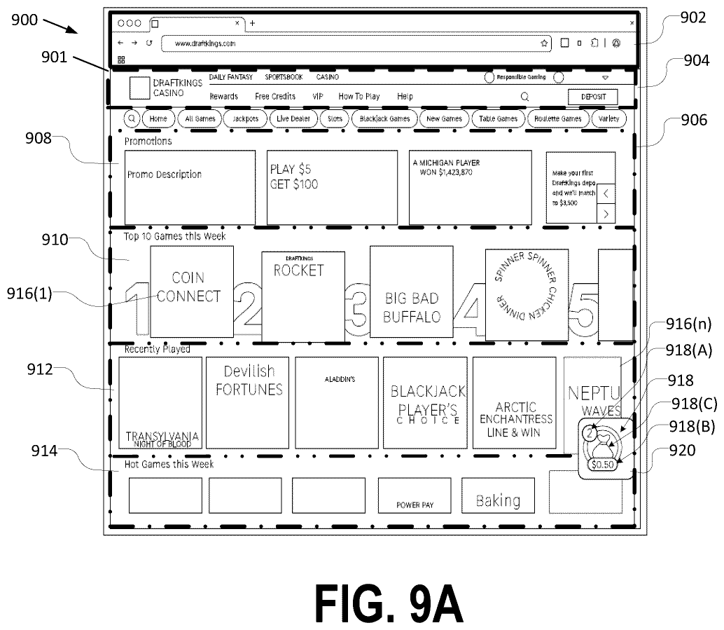

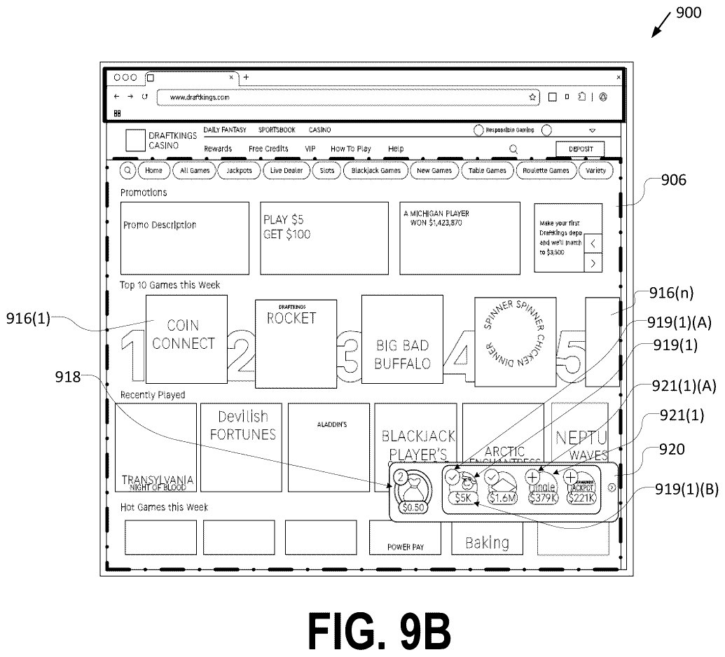

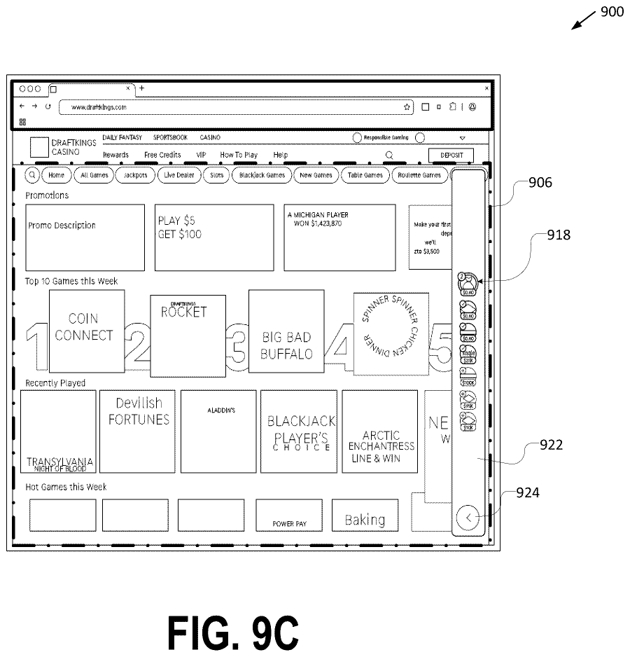

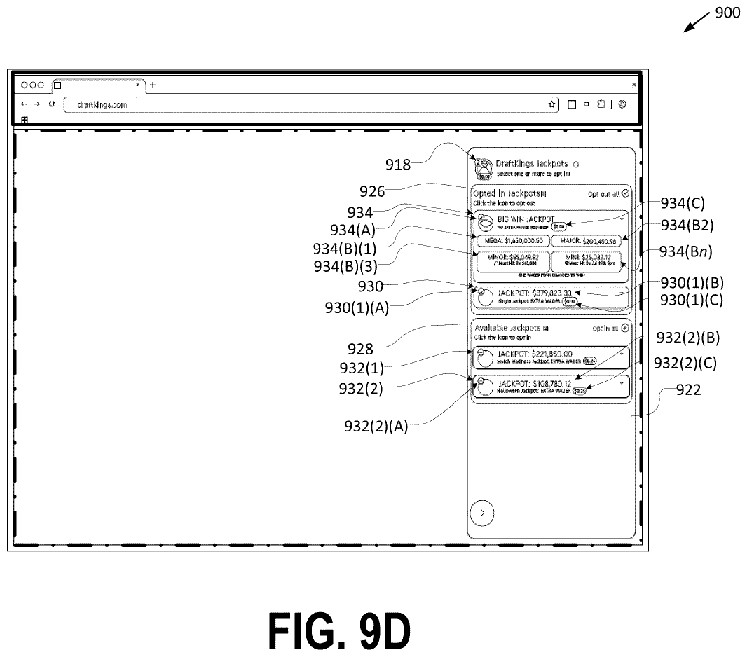

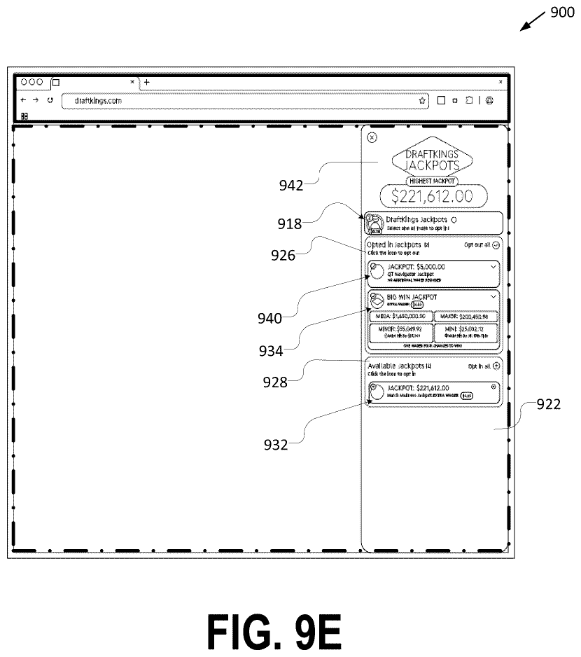

As shown in FIGS. 9A, 9B, 9C, 9D and 9E and with respect to at least one implementation, a first set of screen displays for a web gaming application 900 may be generated as a first graphical user interface (1GUI) 901 on a display device for the PD 102. The 1GUI may be configured to facilitate player participation in an MJG using a web browser, such as, but not limited to, MICROSOFT EDGE or GOOGLE CHROME. Any known and/or later arising user interface technologies, including audio, video and other input/output technologies (as described above) may be used for the 1GUI. Hyperlinks, windows, menus, pointers, scrollbars, text fields, widgets, tabs, buttons, dialog boxes, toolbars and other features and functions known and/or later arising with respect to the 1GUI may be used in implementations of the present disclosure.

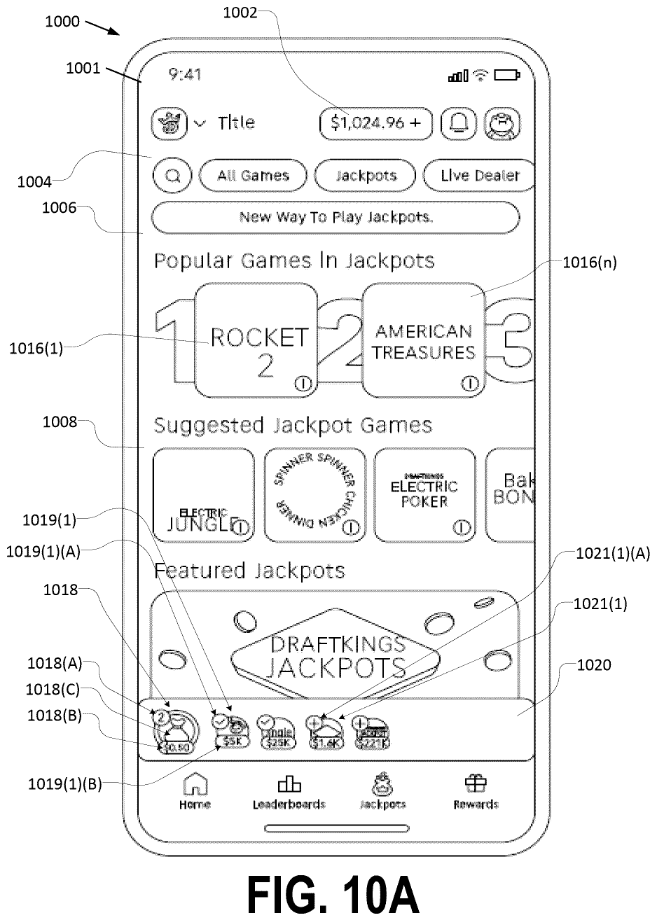

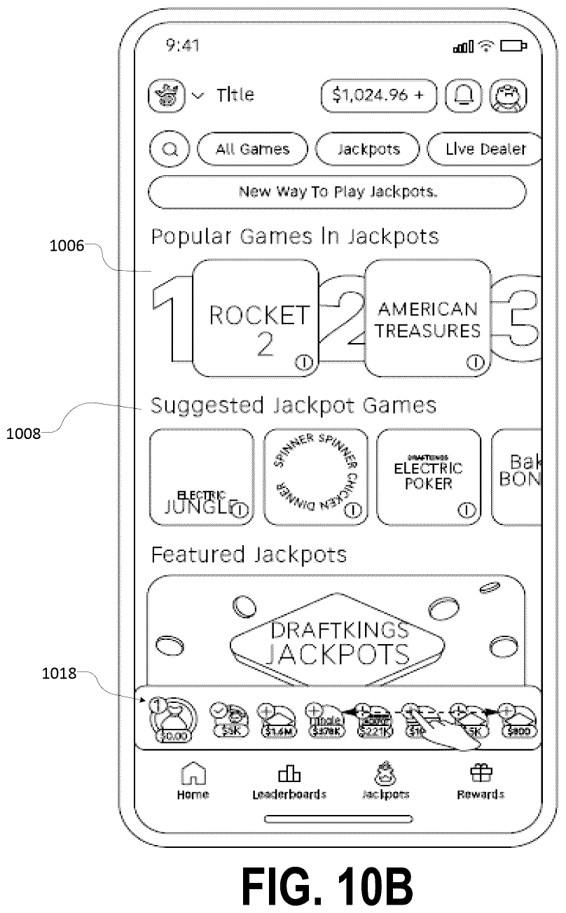

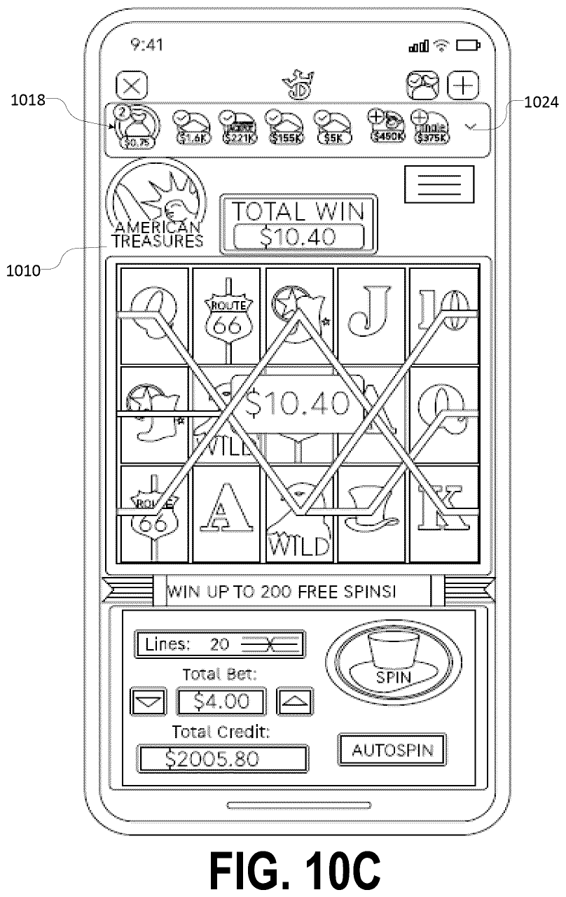

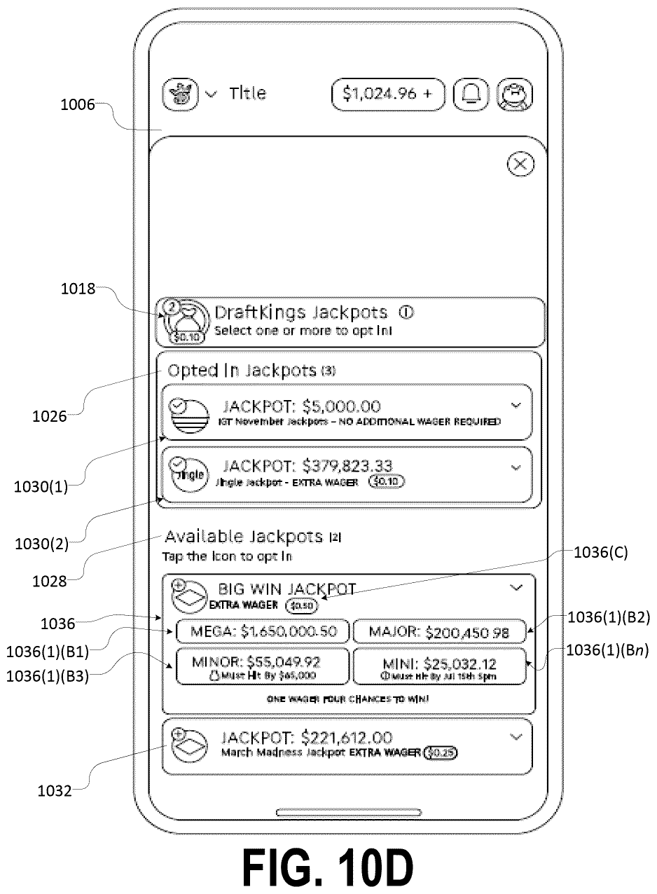

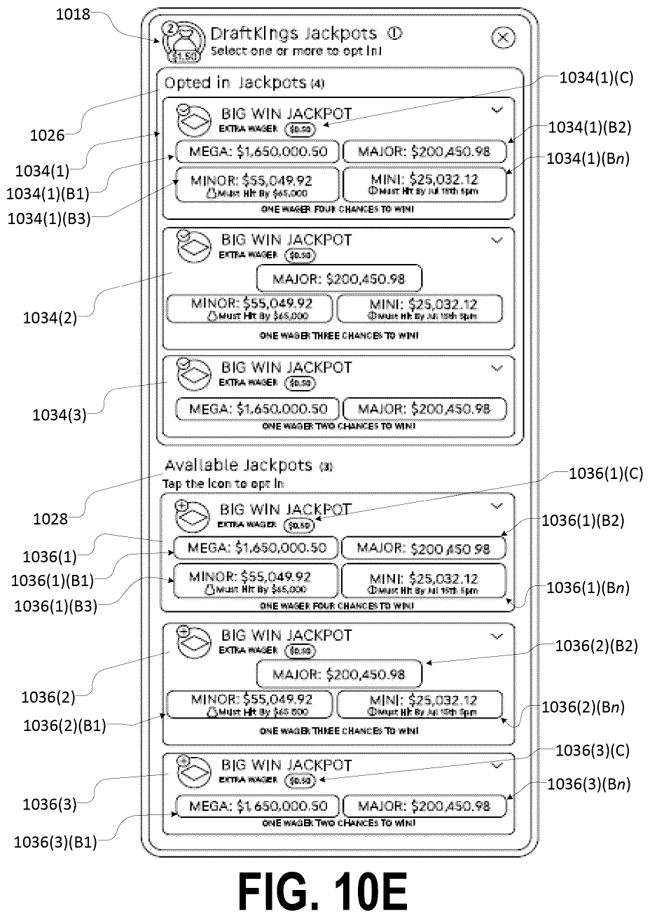

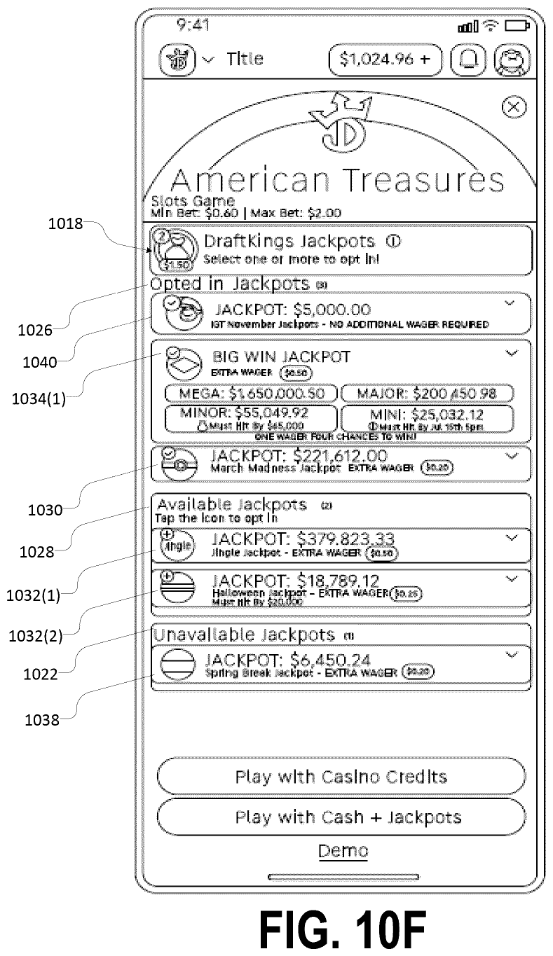

As shown in FIGS. 10A, 10B, 10C, 10D, 10E and 10F and with respect to at least one implementation, a second set of screen displays for a mobile gaming application 1000 may be generated as a second graphical user interface (2GUI) 1001 on a display device for the PD 102. The 2GUI 1001 may be configured to facilitate player participation in an MJG using a mobile device, such as a smartphone, tablet computing device, native application running on a laptop computer, or the like. Any known and/or later arising user devices and/or user interface technologies, including audio, video and other input/output technologies (as described above) may be used for the 2GUI. Hyperlinks, windows, menus, pointers, scrollbars, text fields, widgets, tabs, buttons, dialog boxes, toolbars and other features and functions known and/or later arising with respect to the 1GUI may be used in implementations of the present disclosure.

As shown in FIGS. 9A-9E and for at least one non-limiting implementation, the 1GUI may include an address bar window 902. The address bar window 902, as shown, is enclosed by a thick solid line pattern for purposes of identification only.

The 1GUI 901 and 2GUI 1001 may further include an informational window 904/1004. The informational window 904/1004 may include one or more text boxes or the like providing data regarding how to participate in gaming options provided by the MJGS 100. In FIGS. 9A-9E, the informational window 904 is enclosed in a thick dashed line pattern for purposes of identification only. In FIGS. 10A-10F, the informational window 1004 is shown as being presented at a top portion of a display field provided by the PD 102. The informational window 904/1004 may be presented in other portions of a given GUI, as provided for in at least one implementation of the present disclosure.

For at least one implementation, the 1GUI and 2GUI may include a lobby 906/1006. The lobby 906/1006 may be presented in a separate GUI window, as a portion of a GUI window, or otherwise. In FIGS. 9A-9E, the lobby 906 is enclosed in a thick dot-dashed line pattern for purposes of identification only. The lobby 906/1006 may be populated by the PDLE 106 based on data received, directly or indirectly, from one or more of the PIS 200, OCGAS 300, UMS 400, JGS 500, JDS 540, OCGJITS 600, and/or the AMS 700. For example, and for at least one implementation, account information for the given player may be provided to the PDLE 106 by the AMS 700 and presented in a given GUI component, e.g., as a current account balance button 1002. The current account balance button 1002 may be provided as a widget which, upon being selected by a player, enables the player to access account information and/or perform account/financial related activities, such as depositing funds into their associated account(s), transferring funds, withdrawing funds, or the like.

For at least one implementation, the lobby 906/1006 may be virtually, physically, logically, visibly or otherwise subdivided into two or more portions/windows/areas. For example, a lobby 906/1006 may be apportioned to include a marketing portion 908, an OCG portion 910/1010, a recently played OCG portion 912/1012, and other portions 914/1014. As shown in FIG. 9A, the various portions of the lobby 906 are bisected by a dot-dot-dash line pattern for purposes of identification only.

For at least one implementation, the LobbyOps may include requesting and receiving OCG data from the PDOCGE 108 and jackpot data from the PDMJGE 120. The PDLE 106 may be configured to organize and present one or more instances of the received OCG data and the jackpot data in one or more portions of the lobby 906/1006. One or more of the OCG data and the jackpot data will be dynamically changing—as other players participate/non-participate in a given OCG and thereby in one or more jackpots associated therewith. A given jackpot may be associated with multiple players participating in multiple OCGs, accordingly, current status data regarding the given jackpot (e.g., a current jackpot balance) will be dynamically changing. Accordingly, the PDLE 106 may include operations of substantially continuously requesting and/or receiving new and updated OCG data and jackpot data. For at least one implementation, new and/or updated OCG data and jackpot data may be pulled by a given PDLE 106. For another implementation, new and/or updated OCG data and/or jackpot data may be pushed to a given PDLE 106 by a given JDS 540.

For at least one implementation, a given PDLE 106 may subscribe to one or more event streams, as provided by a given one or more JDSs 540, that contain status and other messages regarding one or more OCGs and/or jackpots. Such event streams may be asynchronous streams and a message for a given OCG event and/or jackpot event (e.g., a jackpot being won) may be communicated to a given PDLE 106 asynchronously.

The PDLE 106 may configure the PD 102 to perform LobbyOps that facilitate substantially contemporaneous processing of asynchronously received messages regarding one or more OCG events and/or jackpot events. The messages may be received from one or more JDS 540. For example, the PDLE 106 may be configured to not update a last reward balance for a jackpot that was already won by the given player or another player when a corresponding award event message is received prior to a balance update message.

For at least one implementation, the LobbyOps may include subscribing to event streams, provided by one or more of the JDS 540 (of which there may be multiple instances at any given time, e.g., as depending on a number of PDs 102 participating in a given OCG and/or a given jackpot). Subscribed event streams may exist for each of a given OCG in which the given player is participating and for each jackpot associated with the given OCG. The LobbyOps may be configured to facilitate the providing of one or more messages received via the one or more event streams to the PDOCGE 108 (for OCG related events) and/or the PMDJGE 120 (for jackpot related events).

The presentation of the OCG data may be as prescribed by the OCGM 110. The presentation of the jackpot data may be as prescribed by the PDMJGE 120. For at least one implementation, one or more modules provided by the PDMJGE 120 may provide one or more presentation settings for one or more jackpots to be utilized by the PDLE 106.

### OCG Engine (PDOCGE) 108

For at least one implementation, PDDS 140 may include second PD 102 computer instructions (2PDCI) that when executed by the PDP 104 instantiate the PDOCGE 108. The PDOCGE 108 configures the PD 102 to perform one or more OCG operations (OCGOps).

The OCGOps may include communicating data with the PDLE 106 regarding one or more OCGs available for participation by a given player at a given time, place, location, device, or otherwise. For at least one implementation, the PDOCGE 108 may be configured to directly communicate requests, and receive one or more replies regarding one or more OCGs to the OCGAS 300.

For at least one implementation, and as shown in FIGS. 9A-9E, the lobby 906 may include two or more OCG buttons 916. The OCG buttons 916(1-n) each correspond to a given OCG and upon selection initiate one or more of the OCGOps.

For at least one implementation, the PDOCGE 108 may be configured to communicate requests for OCG data to the OCGAS 300 and receive one or more replies to such requests from the PIS 200. One or more of the OCGE 208, the GJIE 206 and/or the GLE 204 may be configured to receive OCG data from the OCGAS 300, process the received OCG data into a format suitable for providing to the PD 102, and communicate such processed OCG data to the PDOCGE 108.

The OCGOps may include receiving a selection by a player of an OCG identified in a lobby 906/1006. Upon receiving the OCG selection, the OCGOps may include launching at least one OCG module (OCGM) 110. The OCGM 110 may configure the PD 102 for player participation in the given/selected OCG (such participation being individually and collectively referred to herein as “gameplay”). Participation in a first OCG (e.g., a slot game) may vary from a second OCG (e.g., a card game). A given OCGM 110 provides the GUI features and functions which facilitate participation in the selected OCG by the player.

For an implementation, two or more OCGMs 110 may be used with each OCGM 110 being instantiated as a separate instance, application, web page, on a separate GUI, or the like by and between the PD 102 and one or more of the PIS 200 and the OCGAS 300. For at least one implementation, an OCGM 110 may be configured as an Application Program Interface (API) that enables the PD 102 to communicate OCG data directly and/or indirectly (e.g., via the PIS 200) with the OCGAS 300. It is to be appreciated that different OCGASs 300 may provide gaming functionalities for different instances of OCGs. The OCGM 110 may configure the PD 102 to communicate data with the OCGAS 300 providing the selected OCG gaming functionalities.

For at least one implementation, OCG data may include data that describes one or more OCGs, facilitates selection of an OCG by the PD 102 (e.g., for player participation therein), facilitates gameplay with respect to the at least one OCG selected by the PD 102, and other OCGOps. For at least one implementation, OCG data may be used by the PDLE 106 to render a selected OCG on a PD 102. Such OCG data may be communicated to the PD 102 directly from the OCGAS 300 and/or indirectly via the PIS 200. For at least one implementation, the OCG data may be stored in the PDDS 140 as OCG data 142. As shown, for example and not by limitation in FIGS. 9A-9E and in FIGS. 10A-10F, and for at least one implementation, OCG data 142 may be rendered on a given GUI and include information identifying a given OCG to the given player.

### Multi-Jackpot Gaming Engine (PDMJGE) 120

For at least one implementation, PDDS 140 may include third PD computer instructions (3PDCI) that, when executed by the PDP 104, instantiate the PDMJGE 120. For at least one implementation, the PDMJGE 120 configures the PD 102 to perform one or more MJG Operations (MJGOps). For at least one implementation, the MJGOps may include operations that occur upon a launching of the PDMJGE 120 (herein “launch ops”)—as further described herein. The MJGOps may also include one or more “rendering ops” that facilitate the presentation of information regarding multiple jackpots to the player—as further described herein.

Launch Ops: For at least one implementation, the launch ops may include obtaining an identification of the one or more jackpots associated with the given OCG selected by the player for current participation therein. For an implementation, the PDMJGE 120 may query a Jackpot Data Service (JDS) 540 for jackpot data for currently active jackpots that are associated with the selected OCG. For at least one implementation, the JDS 540 is shown in FIGS. 1A and 5 and is further described below. The launch ops may further include the PDMJGE 120 subscribing to messages, as provided by a given JDS 540, regarding the currently active jackpots associated with the currently selected OCG. For at least one implementation, the JDS 540 may identify the given PD 102 as a jackpot event client that is subscribed to receive updates (e.g., via a push service, a listener service and/or a pull messaging service) regarding one or more currently active jackpots.

For at least one implementation, the launch ops may include activating an MJG Bubble module (BubbleM) 122. The BubbleM 122 may configure the PD 102 to signal the player that one or more jackpots, as provided, for example, in a communication received from the JDS 540, are being participated in by the player and/or may be available for participation by the player. The jackpots may include one or more “opted-in jackpots,” “available jackpots,” “unavailable jackpots”, or other jackpots.

As used herein, an “opted-in” jackpot is a jackpot in which the player is currently participating by default, selection, or otherwise. For example, a given player may participate, by default, in a universal jackpot provided by an MJGS provider. Such participation may occur based upon the given player participating in an OCG at the current time, and/or at a past time. An opted-in jackpot may or may not require the player to agree to a jackpot wager in order to participate in the jackpot.

For at least one implementation, a jackpot wager may be predetermined, dynamically determined (e.g., a wager increasing based upon a current reward amount for the jackpot), or otherwise. A jackpot wager may require a minimum wager, a predetermined wager, or other wager be placed by the player in order for the player to participate in an associated OCG. A jackpot wager may vary based on a number of jackpots in which the given player is currently participating, or otherwise.

As used herein, an “available jackpot” is a jackpot that is associated with a currently active OCG (i.e., an OCG in which the player is participating at current time). An available jackpot may include the player agreeing to an additional jackpot wager amount in order to participate in the jackpot.

As used herein, an “unavailable jackpot” is a jackpot in which a given player, at a given time, place or otherwise is not permitted to participate. Such non-permission may arise due to any factor including, but not limited to, various governmental rules and regulations, player betting history (e.g., a player with an actual or perceived gambling addiction or concern may be prohibited from participating in one or more jackpots in the interest of player safety and the like), player account data, and/or otherwise.

For at least one implementation, the BubbleM 122 may configure the PD 102 to generate one or more jackpot buttons. For at least one implementation, jackpot button may include: a total jackpots button 918/1018 as shown in FIGS. 9A-9E and in FIGS. 10A-10C; one or more opted-in jackpot buttons 919/1019 (as shown in FIGS. 9B-9E and in FIGS. 10A-10C); and one or more available jackpot buttons 921/1021 (as shown in FIGS. 9B-9E and in FIGS. 10A-10C). For at least one implementation, one or more of the jackpot buttons 918/919/921 may be presented on a jackpot button bar 920/1020. For at least one implementation, the jackpot button bar 920/1020 may be generated by the PDMJGE 120 as an overlay that appears to “float” over other actionable items on the PD's user interface 176.

As shown in FIG. 9A and in FIG. 10A, the total jackpot button 918/1018 may include a first text field 918(A)/1018(A) indicating a number (if any) of jackpot games in which the player is currently participating (e.g., the number “2” shown in FIGS. 9A and 10A indicates that the given player is currently participating in two active jackpots). The total jackpot button 918/1018 may also include a second text field 918(B)/1018(B) indicating an amount of a wager to participate in the one or more jackpots. The PDMJGE 120 may be configured to determine the total amount of wager by adding up the individual amount of wager required to participate in each of the one or more jackpots selected by the participant—such amount of wager to participate may be reported by the OCGJTS 600 to the PD 102. The total jackpot button 918/1018 may include a third field 918(C)/1018(C) in which a graphical image, icon or the like may be presented. Selection of the total jackpot button 918/1018 may occur by use of any known and/or later arising user interface technologies including, e.g., by mouse click, touch, voice command, or otherwise.

For at least one implementation, upon player selection of the total jackpot button 918/1018, the horizontal jackpot button bar 920/1020 may expanded horizontally (as shown in FIG. 9B and as further shown in FIGS. 10A-C) and/or vertically, as shown by vertical jackpot button bar 922 (as shown in FIG. 9C.). For at least one implementation, the jackpot button bar 920/1020 may expand from an edge of the web application into the lobby 906/1006, superimposing upon one or more of the OCGs presented, and identifying at least two or more jackpots, each corresponding to a given jackpot button, including opted-in jackpot buttons 919(m)/1018(m), suggested jackpots 1008, and/or available jackpot buttons 921(m)/1021(m), where “m” is an integer and identifies a given instance of a jackpot button. As shown in FIG. 10B for at least one implementation, a player may scroll through the jackpot buttons presented on a given jackpot button bar by use of a touch interface, mouse sliding, or otherwise.

For at least one implementation, the PDLE 106 may be configured to generate and present the horizontal jackpot button bar 920/1020 and/or the vertical jackpot button bar 922 based upon one or more of a predetermined setting, a player determined setting, a number of jackpots available at a given time, or other settings.

For at least one implementation, a jackpot button bar 920/1020/922 may include a jackpot extension button 924/1024, which upon selection thereof, instructs the PD 102 to activate the MJG list module (ListM) 124.

For at least one implementation, the launch ops may include activating the ListM 124. The ListM 124 may configure the PD 102 to classify active jackpots, as subscribed to from the JDS 540, into one or more categories with non-limiting examples including: opted-in jackpots as shown in an opted-in jackpot window 926/1026/1030/1034 (as shown in FIGS. 9D, 9E, 10D, 10E and 10F); available jackpots 928, as shown in an available jackpot window 928/1028/1032 (as shown in FIGS. 9D, 9E, 10D, 10E and 10F); and unavailable jackpots, as identified in an unavailable jackpot window 1022 and unavailable jackpot detail button 1038 (as shown in FIG. 10F). The ListM 124 may utilize lists, categories, windows, groupings or other GUI arrangements to present status information regarding one or more jackpots to the player. For at least one implementation, the jackpots identified by the ListM 124 may be actionable (e.g., a widget selectable by a player by use of a mouse click, touch action, or otherwise that enables the player to opt-in or opt-out of a given jackpot).

For at least one implementation, the ListM 124 may be configured to obtain from the JDS 540 and populate the first text field 918(A) and indicate the number of opted-in jackpots, at a given current time, for the player. The ListM 124 may configure the PD 102 to present information regarding the total amount to be wagered for all opted-in jackpots, as shown in the second text field 918(B).

For at least one implementation, the ListM 124 may configure the PD 102 to present information regarding opted-in jackpots. As shown, an opted-in jackpot button 9(n) may include identifying opted-in jackpots in a first text field 919(A) for a given opted-in jackpot button 919. and/or for a given jackpot, as shown in a.

For at least one implementation, the ListM 124 may configure the PD 102 to present information identifying which of one or more opted-in jackpots. As shown for one or more of the opted-in jackpot buttons 919(n)/1018(n) (as shown in FIGS. 9B-9C and 10A), a check-mark may be presented in a first text field 919(n)(A)/1019(n)(A) to indicate to indicate an opted-in status for a given jackpot.

For at least one implementation, the ListM 124 may configure the PD 102 to present information identifying a reward amount for the one or more opted-in jackpots. As shown for one or more of the opted-in jackpot buttons 919(n)/1018(n) (as shown in FIGS. 9B and 10A), an amount of a current reward may be presented in a second text field 919(n)(B). The current reward amount may be dynamically changing as the given player and/or other players engage in game-play activities that increase and/or decrease the current reward. The PDLE 106 may be configured to subscribe to jackpot event messages, as provided by one or more of the JGS 500 and/or JDS 540.

For at least one implementation, the ListM 124 may configure the PD 102 to present information identifying which of two or more available jackpots. As shown for one or more of available buttons 921(n)/1021(n) (as shown in FIGS. 9B and 10A), a plus (“+”) may be presented in a first text field 921(n)(A)/1021(n)(A) to indicate an available status for a given jackpot.

For at least one implementation, the ListM 124 may configure the PD 102 to present information identifying a reward amount for the one or more available jackpots. As shown for one or more of the available jackpot buttons 921(n)/1021(n) (as shown in FIGS. 9B and 10A), an amount of a current reward may be presented in a second text field 921(n)(B)/1021(n)(B). The current reward amount may be dynamically changing as the given player and/or other players engage in game-play activities that increase and/or decrease the current reward. The PDLE 106 may be configured to subscribe to jackpot event messages, as provided by one or more of the JGS 500 and/or JDS 540.

Rendering Ops: For at least one implementation, the PDMJGE 120 may configure the PD 102 to perform one or more rendering ops. The rendering ops may include activating an MJG Header-Section-Cell module (HSCM) 126 and, for a multi-pot jackpot, an MJG Multi-pot Module (MPotM) 128.

For at least one implementation, the HSCM 126 may configure the PD 102 to present information relating to the given jackpots identified by the BubbleM 122 and/or ListM 124—as selected by a given player for more information about the given jackpot.

For at least one implementation, upon selection of a given opted-in jackpot button 919/1019 or available jackpot button 921/1021 (as shown, e.g., in FIGS. 9B and 10A), the PDMJGE 120 may configure the 1GUI/2GUI (as appropriate) to obtain data for and populate in respective opted-in jackpot windows 926/1026 or available jackpot windows 928/1028, a single pot opted-in jackpot detail window 930/1030, a single pot available jackpot detail window 932, a multi-pot opted-in jackpot detail window 934/1034, a multi-pot available jackpot detail window 1036, and an unavailable jackpot detail window (as shown in FIG. 10F). For at least one implementation, the PDMJGE 120 may utilize the MPotM 128 to populate a multi-pot jackpot detail window 932/1032.

As shown in FIGS. 9D, 9E, 10D, 10E and 10F and for at least one implementation, a single pot opted-in jackpot detail window 930/1030 may include a first field 9(m)(A)/1030(m)(A) indicating that the player has selected the jackpot, where “A” is an alphabetical letter identifier. As shown, the first field may include an icon, such as a check mark, indicating the opted-in status. Other indicators and/or additional indicators (audible, visible, and otherwise) may be used to identify that a given player has opted-in to a given jackpot. The single pot opted-in jackpot detail window 930/1030 may also include a second field 930(m)(B)/1030(B) indicating an amount of reward the jackpot will provide to a winning player, and a third field 930(C)/1030(C) providing an amount of the wager for the jackpot.

As shown in FIGS. 9D, 9E, 10D, 10E and 10F and for at least one implementation, a single pot available jackpot detail window 932/1032 may include a first field 932(m)(A)/1032(m)(A) indicating that the jackpot is available for selection by the player. As shown, the first field may include an icon, such as a “+” mark indicating the available status. Other indicators and/or additional indicators (audible, visible, and otherwise) may be used to identify that a given jackpot is available to the player. The single pot available jackpot detail window 932/1032 may also include a second field 932(m)(B)/1032(m)(B) indicating an amount of reward the jackpot will provide to a winning player, and a third field 932(m)(C)/1032(m)(C) providing an amount of the wager to participate in the jackpot.

As shown in FIGS. 9D, 9E, 10D, 10E and 10F and for at least one implementation, a multi-pot opted-in jackpot detail window 934/1034 may include a first field 934(m)(A)/1034(m)(A) indicating that the player has selected the jackpot. As shown, the first field may include an icon, such as a check mark, indicating the opted-in status. Other indicators and/or additional indicators (audible, visible, and otherwise) may be used to identify that a given player has opted-in to a given jackpot. The multi-pot opted-in jackpot detail window 930/1030 may include two or more second fields 934(m)(Bn)/1034(m)(Bn), (wherein “n” is an integer) indicating an amount of reward the jackpot will provide to a winning player based on a multi-pot type, such as a “Mega pot”, a “Major pot”, a “Minor pot”, and a “Mini pot.”

As shown in FIGS. 10D, 10E and 10F and for at least one implementation, a multi-pot available jackpot detail window 1036 may include a first field 1036(m)(A) indicating that the jackpot is available for the player to select. As shown, the first field may include an icon, such as a check mark, indicating the available status. Other indicators and/or additional indicators (audible, visible, and otherwise) may be used to identify that a given jackpot is available to the player. The multi-pot available jackpot detail window 1036 may include two or more second fields 1036(m)(Bn), (wherein “n” is an integer) indicating an amount of reward the jackpot will provide to a winning player based on a multi-pot type, such as a “Mega pot”, a “Major pot”, a “Minor pot”, and a “Mini pot.”

For at least one implementation, a “Mega pot” is a jackpot with a reward of one-thousand to ten-thousand times (1,000-10,000×) the players stake, a “Major pot” is a jackpot with a reward of five hundred to one-thousand times (500-1000×) the players stake, a “Minor pot” is a jackpot with a reward of fifty to two hundred times (50-200×) the players stake, and a “Mini pot” is a jackpot with a reward of ten to fifty times (10-50×) the players stake. Other reward ranges may be used for other implementations. As shown, a multi-pot jackpot may include two or more rewards. The multi-pot opted-in jackpot detail window 934/1034 may include a third field 934(m)(C)/1034(m)(C) providing an amount of a current wager to participate in the jackpot.

It is to be appreciated that the current value of a given jackpot will typically be continually changing based on wagers placed by the given player and other players. As described above, the placing, communicating, and processing of such wagers occurs asynchronously (for at least one implementation) and multiple gaming engines JGE(n)s 504 may be used to process wager placements, multiple instances of the OCGJTS 600 may be used, and multiple instances of the JDS 540 may be used to minimize communication and processing delays arising from placements of wagers on OCGs and associated jackpots to which the given player(s) have opted-in. Accordingly, and for at least one implementation, the value reflected at any given time in the second field 930(m)(B)/932(m)(B)/934(m)(B)/1030(m)(B)/1032(m)(B)/1034(m)(B) and/or 1036(m)(B) may be substantially equivalent (e.g., not deviating by more than ten percent (10%) from an actual value, when all wagers and jackpot processing activities have been accounted for as of a given time). For at least one implementation, the current wager may be fixed, dynamically priced (e.g., based upon level of participation, reward amount, time based, or otherwise). For at least one implementation, the HSCM 126 may obtain jackpot status data, including current reward data and current wager data from one or more of the PIS 200, the JGS 500, the OCGJTS 600, and the JDS 540.

For at least one implementation, the launch ops may include subscribing the PD 102 to one or more jackpots associated with the MJGS provider (herein, each a “provider jackpot” 940/1040, as shown in FIGS. 9E and 10F). As used herein, a provider jackpot may be associated with multiple games and may be available for a given player to participate in provided the given player is participating in an OCG and without requiring a wager by the player. For at least one implementation, a provider jackpot 940/1040 may be considered a universal jackpot in which all eligible players participate. Such participation may occur automatically, e.g., without requiring the given player to opt-in or otherwise selecting to participate in a given provider jackpot.

As shown in FIG. 9E, the PDGMJE 120 may be configured to utilize a marketing module (MarketM) 130 configured to monitor the active jackpots currently being provided by an MJGS operator for wins. The active jackpots may be provided in a toasts window 942 and may include opted-in jackpots, available jackpots and unavailable jackpots. For at least one implementation, the MarketM may receive communications regarding won jackpots by subscribing to one receive push notifications from the JDS 540, which may be based on notifications provided by a corresponding JGE 504(n) and/or the JGS 500. For at least one implementation, the MarketM 130 may listen to one or more data streams provided one or more of the JGS 500 and the JDS 540, periodically poll the JGS 500 for jackpot win notifications, or otherwise actively and/or passively monitor communications between the various MJGS 100 components for indications that a jackpot has been won.

For at least one implementation, the JDS 540 may generate and utilize one or more state models that provide, based on data received from each of the JGEs 504(n), a current status for each active jackpot. The state models may also include data for previously active jackpots. The state models may be updated as jackpot rewards amounts change, jackpots are won, jackpot wagers change, jackpots are added or deleted (e.g., upon a win event occurring), an identification of PDs 102 participating in a given jackpot, and other jackpot related data. The JDS 540 may publish changes by generating one or more status update messages to a jackpot message queue to which each of the various PDs 102 currently active in the MJGS 100 may subscribe. Messages may be placed on the jackpot queue when, e.g., a given jackpot's status change equals or exceeds one or more thresholds. Such thresholds may be predetermined, variably determined, player specified, MJGS 100 operator specified, governmentally specified, or otherwise determined. Multiple instances of the jackpot state models, and multiple instance of the jackpot message queue may exist at any given time on the Cloud or otherwise to facilitate load balancing and operational efficiencies of the MJGS 100.

### Player Interface Service (PIS) 200

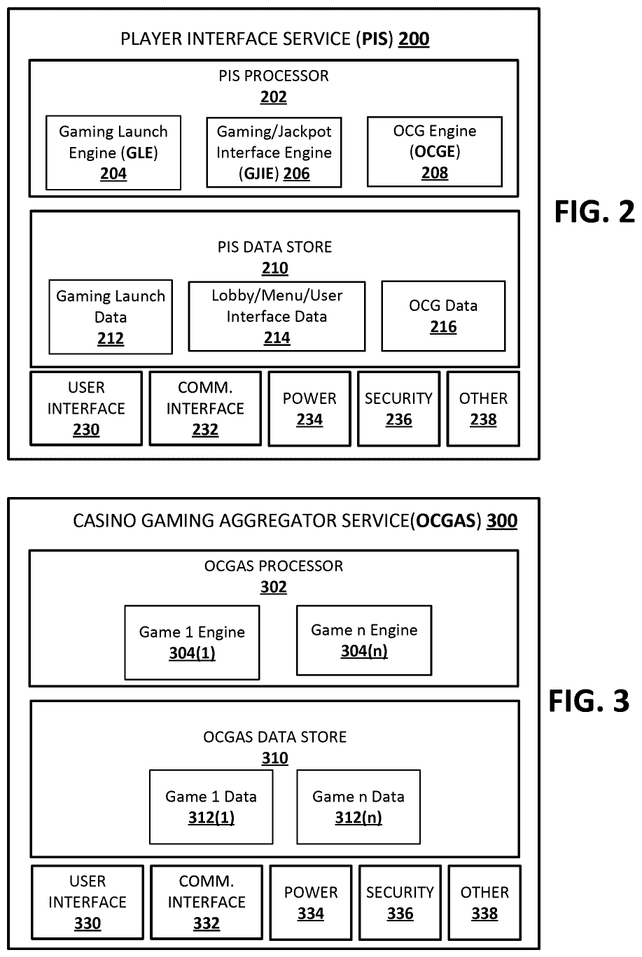

As shown in FIG. 2, as further described in the DK15 App., and in accordance with at least one implementation, the PIS 200 may include a PIS processor 202 configured to execute, respectively, first, second and third PIS computer instructions which instantiate one or more of a gaming launch engine (GLE) 204, a gaming/jackpot interface engine (GJIE) 206, and an OCG engine (OCGE) 208. The GLE 204, pursuant to the first PIS computer instructions (1PISCI), configures the PIS 200 to perform gaming launch operations (GLOs). The GJIE 206, pursuant to the second PIS computer instructions (2PISCI), configure the PIS 200 to perform gaming and jackpot interface operations (GJIO). The OCGE 208, pursuant to the third PIS computer instructions (3PISCI), configures the PIS 200 to perform one or more OCG operations (OCGO). The PIS 200 may be configured to fetch an update data regarding an OCG and MJGs available to and/or being “played” by a player at a given time.

It is to be appreciated that the reference to first, second, third or the like is used herein for purposes explanation of implementations of the present disclosure and are not to be construed to require a particular sequence of events, operations, or the like.

The 1PISCI, 2PISCI and 3PISCI may be non-transitorily stored in a PIS data store 210 coupled to the PIS processor 202 by a bus (not shown) or other direct or indirect coupling. The GLE 204 may utilize data stored in the PIS data store 210 as gaming launch data. The GJIE 206 may utilize data stored in the PIS data store 210 as one or more of lobby, menu, and/or user interface data 214. The OCGE 208 may utilize data stored in the PIS data store 210 as OCG data 216.

Gaming Launch Engine (GLE) 204: For at least one implementation, the GLE 204 may be configured to launch a player into an OCG. The GLE 204, GJIE 206 and OCGE 208 may be configured to fetch and update (as appropriate) player and OCG specific data. Such data may be presented to a player, via a player device user interface to inform the player of an OCG mode, OCG credit balance, player and OCG permissions, jackpot configurations and availabilities, and a gameplay mode requested by the player (for example, a MJG gameplay mode). To fetch and update such data, one or more of the GLE 204, GJIE 206 and OCGE 208 may request data, directly or indirectly, from one or more of the OCGAS 300, the UMS 400, the JGS 500, the OCGJTS 600, and the AMS 700. Data retrieved pursuant to one or more of such operations may be non-transitorily stored in the PIS data store 210 and/or elsewhere in the MJGS 100.

Gaming/Jackpot Interface Engine (GJIE) 206: For at least one implementation, the GJIE 206 may be configured to manage configurations of games, jackpots, and lobbies, as ultimately presented on a graphical user interface (GUI) provided by a PD 102. The GJIE 206 may be configured to retrieve data regarding OCGs from the OCGAS 300 and/or other MJGS 100 components based on gaming category. Additional data useful in configuring the GUI on the PD 102 may be processed by the GJIE 206. For at least one implementation, the data obtained by the GJIE 206 from the MJGS 100 components may include data providing strategy for launch of a jackpot game, jackpot round outcome retrieval results, and other data regarding each of two or more jackpots available to PD 102. For at least one implementation, such data may further include data regarding one or more jackpots that are unavailable to the PD 102, jackpots currently active, past jackpots played, and the like.

Online Casino Game Engine (OCGE) 208: for at least one implementation, the OCGE 208 may be configured as an interface for gameplay requests to and from the OCGAS 300. It is to be appreciated that each OCGAS 300, of which there may be many for a given MJGS 100, may utilize a unique command, data, and other structure. Accordingly, the OCGE 208 may be configured to include multiple interfaces with at least one interface being provided for each OCGAS 300 utilized in conjunction with a given implementation of an MJGS 100. The OCGE 208 may be further configured to include one or more instance of OCGAS 300 interface logic which enables the MJGS 100 to process and send requests from and to the OCGEs 208 utilized. The OCGE 208 may be configured to forward the as processed request to and from the OCGASs 300 used in a given implementation to other MJGS 100 components, such as the GJIE 206 and others.

### Online Casino Gaming Aggregator Service (OCGAS) 300

As shown in FIG. 3, as further described in the DK15 App., and in accordance with at least one implementation, the OCGAS 300 may include an OCGAS processor 302 configured to execute, respectively, first through nth OCGAS computer instructions (nOCGCIs) which instantiate one or more of a first game engine (GE1) 304(1) through an nth game engine (GEn) 304(n). A gaming engine (GE) 304 is configured to perform one or more gaming aggregator operations (GAOs) that may include, without limitation, processing a player's virtual game play actions, example, a pulling of a slot machine lever, a selection of a roulette number, a throwing of craps dice, or the like and applying established game logic and rules, determine a result of the game play action (e.g., a win, draw, pass, loss, or the like). It is to be appreciated that a game play action in which a player may virtually partake is OCG dependent and may vary from one OCG to another.

The nOCG-Cis may be non-transitorily stored in an OCGAS data store 310 coupled to the OCGAS processor 302 by a bus (not shown) or other direct or indirect coupling. A GEn 304(n) may utilize data stored in the OCGAS data store 310 to provide OCG data to a PD 102 or another component of the MJGS 100. The OCGE 208 may store data in the OCGAS data store 310 as Game (1-n) data 312(1-n).

### User Management Service (UMS) 400

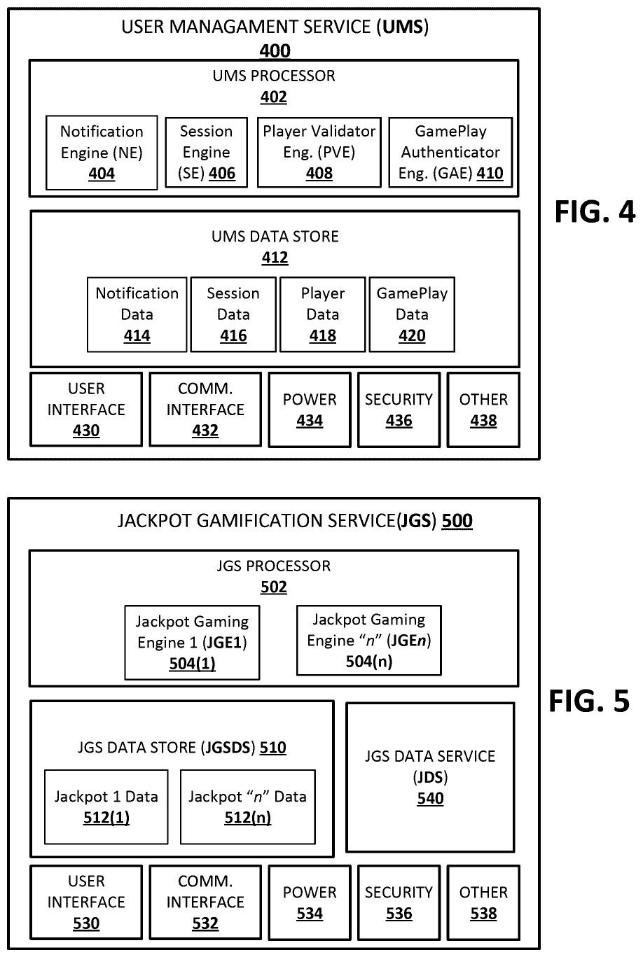

As shown in FIG. 4, as further described in the DK15 App., and in accordance with at least one implementation, the UMS 400 may include a UMS processor 402 configured to execute, respectively, 1st through 4th UMS computer instructions (nUMSCIs) which respectively instantiate a notification engine (NE) 404, a session engine (SE) 406, a player validator engine (PVE) 408, and a gameplay authenticator engine (GAE) 410.

The nUMSCIs and data used by the UMS engines may be non-transitorily stored in a UMS data store 412 coupled to the UMS processor 402 by a bus (not shown) or other direct or indirect coupling. A UMSCI may utilize data stored in the UMS data store 412 to provide data and/or computer instructions for use by one or more of the NE 404, SE 406, PVE 408, GAE 410, and/or another component of the MJGS 100. The UMS 400 may store data in the UMS data store 412 as one or more of notification data 414, session data 416, player data 418, gameplay data 420, and/or other data.

Notification Engine (NE) 404: For at least one implementation, the NE 404 may be configured implement 1UMSCIs that configure the UMS 400 to perform one or more notification engine operations (NEOs). For at least one implementation, the NEOs may include communicating notifications to the PD 102. The notifications may include data provided by one or more other MJGS 100 components. The NE 404 may non-transitorily store notifications in the UMS data store 412 as notification data 414. Such notifications may be communicated in any order sequence, synchronously, asynchronously, or otherwise. For at least one implementation, operations performed by the MJGS may be performed asynchronously and notifications communicated, by the NE 404 to the PD 102 asynchronously.

Session Engine (SE) 406: For at least one implementation, the SE 406 may be configured to implement 2UMSCIs that configure the UMS 400 to perform one or more session engine operations (SEOs). For at least one implementation, the SEOs may include managing each gaming session. The SEOs may include receiving data from other MJGS components regarding the player, games and jackpots being played, and the like. The SEOs may include providing an interface by which a gaming session may be created, validated, extended, terminated, or the like. Data generated by and/or utilized by the SE 406 may be non-transitorily stored in the UMS data store 412 as session data 416.

Player Validator Engine (PVE) 408: For at least one implementation, the PVE 408 may be configured to implement 3UMSCIs that configure the UMS 400 to perform one or more player validator engine operations (PVEOs). For at least one implementation, the PVEOs may include managing player data including receiving, storing, validating, monitoring and/otherwise managing players for participation in a given session, OCG and/or one or more jackpots. Such data may be non-transitorily stored in the UMS data store 412 as player data 418. The operations of the PVE 408 are beyond the scope of the present disclosure and any known or later arising devices, systems, process, or the like for validating and/or managing players with respect to one or more OCGs and/or one or more jackpots may be utilized in an implementation of the present disclosure.

Gameplay Authenticator Engine (GAE) 410: For at least one implementation, the GAE 410 may be configured to implement 4UMSCIs that configure the UMS 400 to perform one or more gameplay authenticator engine operations (GAEOs). For at least one implementation, the GAEOs may include monitoring and authenticating OCG and jackpot gameplay actions The GAE 410 may utilize various data regarding rules, permissions, actions permissible, actions impermissible, and the like (herein “gaming rules”) regarding each of the OCGs and jackpots provide by the MJGS 100. It is to be appreciated that gaming rules may vary by OCG, jackpot, player, jurisdiction, and otherwise. Accordingly, and for at least one implementation, the GAE 410 may non-transitorily store such gaming rules and other data relating to a generic OCG and/or jackpot as well as player specific data relating thereto in the UMS data store 412 as gameplay data 420.

### Jackpot Gamification Service (JGS) 500

As shown in FIG. 5, as further described in the DK15 App., and in accordance with at least one implementation, the JGS 500 may include a JGS processor 502 configured to execute, respectively, 1st through nth JGS computer instructions (nJGSCIs) which respectively instantiate each instance of one (1) to n jackpot gaming engines (JGEn's) 504, shown as JGE 1 504(1) through JGEn 504(n). A given JGE may be configured to perform one or more jackpot operations (JPOs). The JPOs performed may vary by jackpot and may commonly include acceptance of a jackpot and a corresponding wager amount to be debited against a given player's account upon performance of a gameplay turn in an OCG associated with the given jackpot. For example, an OCG (such as a slot machine game) may include a minimum wager of one dollar ($1.00). A first jackpot associated with the OCG may include a wager of ten cents ($0.10) and a second jackpot associated with the OCG may include a wager of twenty cents ($0.20). Accordingly, with a given player elects to both take a spin of the slot machine wheel (by pulling a virtual slot machine arm) and participate in both the first jackpot and the second jackpot, a wager amount of $1.30 will be debited against the players account.

The nJGSCIs and data used by the JGEs may be non-transitorily stored in a JGS data store 510 coupled to the JGS processor 502 by a bus (not shown) or other direct or indirect coupling. A JGSCI may utilize data stored in the JGS data store 510 to provide data and/or computer instructions for use by one or more of the JGEn's and/or another component of the MJGS 100. The JGS processor 502 may store data in the JGS data store 510 as one or more of jackpot 1 data 512(1) through jackpot n data 512(n), and/or other data. The data used by a given JGEn to facilitate a jackpot may include utilize “jackpot rules” regarding the presentation, playing, reporting of results, and the like for each of two or more given jackpots. It is to be appreciated that such jackpot rules may vary by jackpot, underlying OCG being played, jurisdiction, and otherwise.

For at least one implementation, the JGS may include and/or be coupled to a JGS data service (JDS) 540. The JDS 540 provides, upon request, and/or publishes to subscribing components of the MJGS 100 (which may include the PD 102, the PIS 200 and other components) a listing of jackpots currently active, amounts of the currently active, jackpots, and updates thereto the currently active jackpots. The PD 102 may be configured to subscribe to receive updates from the JDS 540. The JDS 540 may receive such updates from each of the jackpot gaming engines 504 active at a given current time. The JDS 540 may be configured to associate currently active jackpots, and publish updates thereto, to those PD 102 that are currently actively participating in an OCG associated with a given one or more currently active jackpots. Accordingly, the MJGS 100 may be configured such that the providing of updates to currently active jackpots to the PDs 102 currently participating therein can be separated from the providing of the jackpot game statuses, as provided by each of the jackpot gaming engines 504, then currently active.

For at least one implementation, the JDS 540 may be scaled up/down to include multiple instances thereof which can support the timely providing of jackpot updates to the often numerous (thousands or more) of PDs 102 that may be currently actively participating in each of two or more jackpots.

For at least one implementation, the JDS 540 may be provided as a service of the JGS 500 and/or as a separate service. When provided as a separate service, one or more additional direct and/or indirect couplings between the PD 102 and the JDS 500, the PIS 200 and the JGS 540, and otherwise, may be utilized.

### OCG and Jackpot Transaction Service (OCGJTS) 600

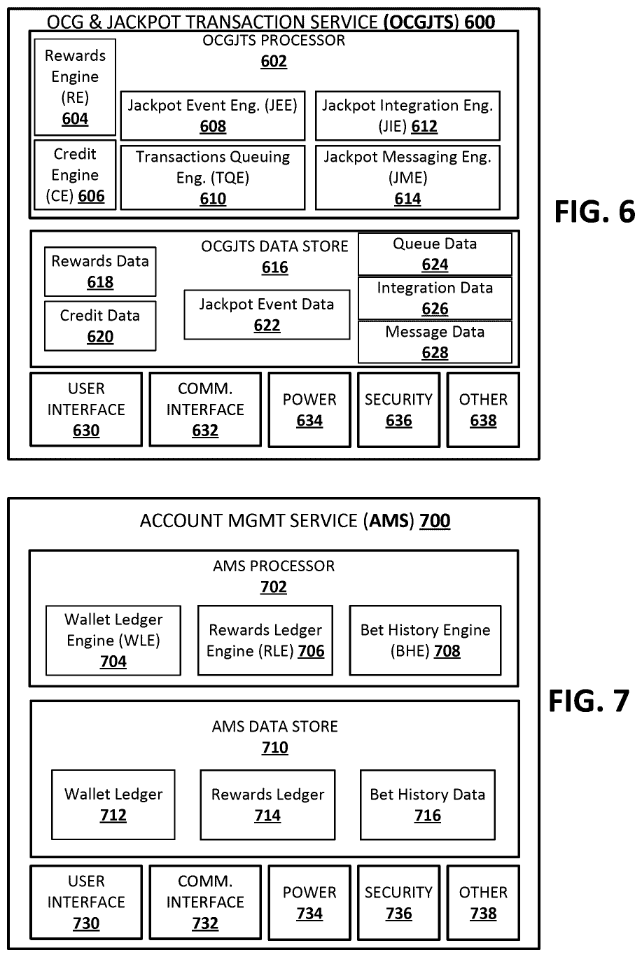

As shown in FIG. 6, as further described in the DK15 App., and in accordance with at least one implementation, the OCGJTS 600 may include an OCGJTS processor 602 configured to execute, respectively, 1st through 6^{th} OCGJTS computer instructions (OCGJTSCIs) which respectively instantiate a rewards engine (RE) 604, a credit engine (CE) 606, a jackpot event engine (JEE) 608, a transactions queueing engine (TQE) PDLE, a jackpot integration engine (JIE) 612, and a jackpot messaging engine (JME) 614.

The OCGJTSCIs and data used by the RE 604, CE 606, JEE 608, TQE 610, JIE 612 and/or JME 614 may be non-transitorily stored in an OCGJTS data store 616 coupled to the OCGJTS processor 602 by a bus (not shown) or other direct or indirect coupling. An OCGJTSCI may utilize data stored in the OCGJTS data store 616 to provide data and/or computer instructions for use by one or more of the foregoing engines and/or other component of the MJGS 100 to process financial transactions related to the playing of an OCG and multiple jackpot games associated with the OCG gameplay. The OCGJTS processor 602 may store data in the OCGJTS data store 616 as one or more of rewards data 618, credit data 620, jackpot event data 622, queue data 624, integration data 626, message data 628, and/or other data. The data used by a given OCGJTS engine to facilitate transactional aspects of game play may vary by the OCG and/or jackpots being played at a given time and by a given player.

Rewards Engine (RE) 604: For at least one implementation, the RE 604 may be configured to implement 1OCGJTSCIs that configure the OCGJTS 600 to perform one or more rewards engine operations (REOs) including processing rewards arising from gameplay, or otherwise provided by an MJGS operator to a given player. For at least one implementation, rewards may be utilized in conjunction with a given, one or more OCGs but may not be used to satisfy any wager amounts required from a player to participate in a jackpot. For another implementation, rewards may be used for participation in OCGs and/or jackpots. The RE 604 may be configured to communicate with the AMS 700 when rewards are redeemed by a given participant. The RE 604 may utilize and/or store the rewards data 618 in the OCGJTS data store 616 and/or in other MJGS 100 components.

Credit Engine (CE) 606: For at least one implementation, the OCGJTS processor 602 may configure to implement 2OCGJTSCIs that configure the OCGJTS 600 to perform one or credit engine operations (CEOs) including processing credit transactions (as opposed to reward transactions) arising from gameplay by a player in an OCG and/or one or more jackpots. The CE 606 may utilize and/or store the credit data 620 in the OCGJTS data store 616 and/or in other MJGS 100 components.

Jackpot Event Engine (JEE) 608: For at least one implementation, the JEE 608 may configure to implement 3OCGJTSCIs that configure the OCGJTS 600 to perform one or jackpot event engine operations (JEEOs). The JEE 608 may utilize and/or store the jackpot event data 622 in the OCGJTS data store 616 and/or in other MJGS 100 components.

Transactions Queuing Engine (TQE) 610: For at least one implementation, the TQE 610 may configure to implement 4OCGJTSCIs that configure the OCGJTS 600 to perform one or transaction queueing engine operations (TQEOs) including receiving a managing, in a queue or other data structure, data from the JEE 608 indicative of one or more jackpot events. For at least one implementation, the MJGS 100 may utilize an asynchronous data processing environment. The TQE 610 facilitates the ordered processing of jackpot event data, even when such data is not received synchronously. The TQE 610 may utilize and/or store the queue data 624 in the OCGJTS data store 616 and/or in other MJGS 100 components.

Jackpot Integration Engine (JIE) 612: For at least one implementation, the JIE 612 may configure to implement 5OCGJTSCIs that configure the OCGJTS 600 to perform one or jackpot integration engine operations (JIEOs) including integrating a casino platform, on which a given of one or more OCGs may be presented for play by a player at any given time, with a jackpot platform, one which one or more jackpots including multi-jackpot games, may be also presented to the given player at a given time. For at least one implementation the JIEOs may include negotiating authentication tokens for use in OCG web based and native (application) based implementations, wherein the authentication tokens may also be utilized to get jackpot games, jackpot events, and jackpot winnings data from the JGS 500 and/or other MJGS 100 components. For at least one implementation, the JIEOs may include communicating OCG winnings to the JGS 500 to determine if a winning OCG gameplay qualifies as a win for one or more jackpots in which a given player has selected to participate in conjunction with the player's participation in the given OCG. For at least one implementation, the JIEOs may include receiving notification form the JGS 500 when a jackpot has been won by a given player and further communicating the winning jackpot event to the AMS 700 for processing thereby and crediting of the given player's account with the amount of the jackpot winnings or the like. The JIE 612 may utilize and/or store the integration data 626 in the OCGJTS data store 616 and/or in other MJGS 100 components.

Jackpot Messaging Engine (JME) 614: For at least one implementation, the JME 614 may be configured to implement 5OCGJTSCIs that configure the OCGJTS 600 to perform one or jackpot messaging engine operations (JMEOs) including communicating data from one or more of the CE 606, the JIE 612, and/or other MJGS 100 components to the AMS 700 for processing thereby. The JME 614 may utilize and/or store queue data 624 in the OCGJTS data store 616 and/or in other MJGS 100 components.

### Account Management Service (AMS) 700

As shown in FIG. 7, as further described in the DK15 App., and in accordance with at least one implementation, the AMS 700 may include an AMS processor 702 configured to execute, respectively, 1st through 3^{rd} AMS computer instructions (AMSCIs) which respectively instantiate a wallet ledger engine (WLE) 704, a rewards ledger engine (RLE) 706, and a bet history engine (BHE) 708.

The AMSCIs and data used by the WLE 704, RLE 706, and BHE 708 may be non-transitorily stored in an AMS data store 710 coupled to the AMS processor 702 by a bus (not shown) or other direct or indirect coupling. An AMSCI may utilize data stored in the AMS data store 710 to provide data and/or computer instructions for use by one or more of the foregoing engines and/or other component of the MJGS 100 to process financial transactions related to the playing of an OCG and multiple jackpot games associated with the OCG gameplay. The AMS processor 702 may store data in the AMS data store 710 as one or more of a wallet ledger 712, a rewards ledger 714, as bet history data 716, and/or other data. The data used by a given AMS engine to facilitate transactional aspects of game play may vary by the OCG and/or jackpots being played at a given time and by a given player.

Wallet Ledger Engine (WLE) 704: For at least one implementation, the WLE 704 may be configured to implement 1AMSCIs that configure the AMS 700 to perform wallet engine operations (WLEOs) including maintaining account records for each player participating in the MJGS 100 at any given time. The account records may include debits and credits to a wallet ledger 712 maintained in the AMS data store 710. A distinct wallet ledger 712 may be maintained for each player.

Rewards Ledger Engine (RLE) 706: For at least one implementation, the RLE 706 may be configured to implement 2AMSCIs that configure the AMS 700 to perform rewards ledger engine operations (RLEOs) including maintaining rewards records for each player participating in the MJGS 100 at any given time. The rewards records may include debits and credits to a rewards ledger 714 maintained in the AMS data store 710. A distinct rewards ledger 714 may be maintained for each player.

Bet History Engine (BHE) 708: For at least one implementation, the BHE 708 may be configured to implement 3AMSCIs that configure the AMS 700 to perform bet history engine operations (BHEOs) including maintaining records for each bet placed by a given player participating in the MJGS 100 at any given time. The bet history records may include hands played, bets placed, results of game play and any other data relating to a given player's participating in a “hand” (or “spin” or other distinct gameplay event) for an OCG and/or one or more jackpots associated with a given one or more OCGs (collectively, a “player's betting history”). The players betting history may be stored as bet history data 716 in one or more files or other data structures maintained in the AMS data store 710. A distinct bet history data 716 may be maintained for each player.

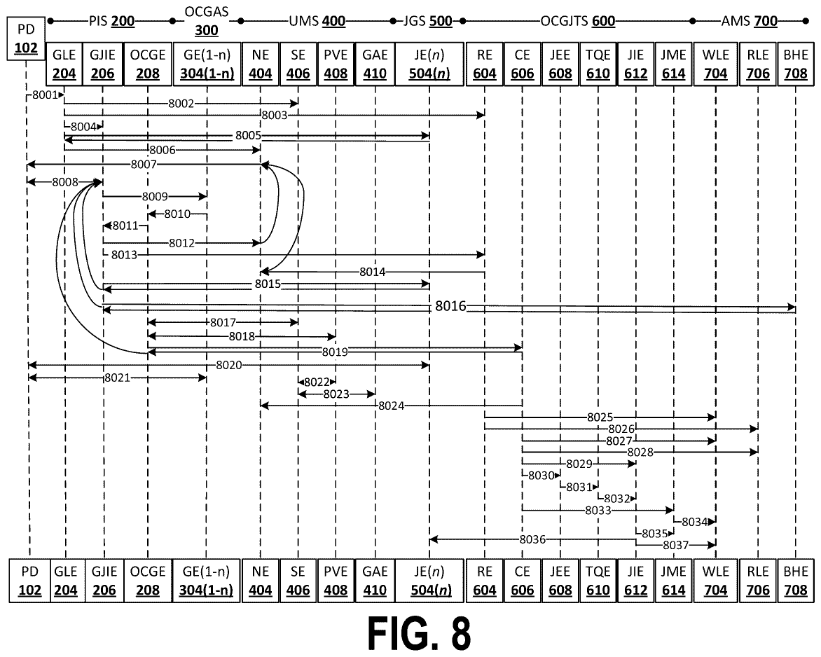

As shown in FIG. 8 and for at least one implementation of the present disclosure, operations performed by the PIS 200, via one or more of the GLE 204, the GJIE 206 and the OCGE 208, may include a first operation (1^{st} Op) 8001 of receiving, by the GLE 204, an identification of a given player from the player device 102. Data received pursuant to the first operation 901 may be non-transitorily stored in the PIS data store 210 and/or elsewhere in the MJGS 100.

As further shown in FIG. 8 for at least one implementation of the present disclosure, a second operation (2^{nd} Op) 8002, may include the GLE 204 querying a session engine (SE) 406 (as described hereinbelow) instantiated by the UMS 400, for a player session identifier and a play mode for a given player identified by the player device 102. Data retrieved pursuant to the second operation may be non-transitorily stored in the PIS data store 210, the UMS data store 412, and/or elsewhere in the MJGS 100.

As further shown in FIG. 8 for at least one implementation of the present disclosure, a third operation (3^{rd} Op) 8003 may include the GLE 204 querying a rewards engine (RE) 604 (as described hereinbelow and as instantiated by the OCGJTS 600) for any rewards to which the given player has earned or is otherwise entitled. Data retrieved pursuant to the third operation may be non-transitorily stored in the PIS data store 210, the OCGJTS data store 616 and/or elsewhere in the MJGS 100.

As further shown in FIG. 8 for at least one implementation of the present disclosure, a fourth operation (4^{th} Op) 8004 may include the GLE 204 querying the gaming jackpot interface engine (GJIE) 206 for jackpot data 512 associated with an OCG selected by the player. This operation may be repeated with respect to each of “n” jackpots that may be associated, at any given time, with a given OCG selected by the player. For at least one implementation, the GJIE 206 may be configured to request and receive data regarding up to ten (10) jackpots that may be made available to a given player to wager against and with respect to gameplay arising for given OCG selected by the player. Data retrieved pursuant to the 4^{th} Op 8004 may be non-transitorily stored in the PIS data store 210, the JGS data store 510, and/or elsewhere in the MJGS 100.

As further shown in FIG. 8 for at least one implementation of the present disclosure, a fifth operation (5^{th} Op) 8005 may include the GLE 204 querying each of one or more jackpot engines JE(1-n) as instantiated by the JGS 500, for an identification of one or more (“n”) jackpots available for play by the player in view of the data returned via the 4^{th} Op 8004. Data retrieved pursuant to the 5^{th} Op 8005 may be non-transitorily stored in the PIS data store 210, the JGS data store 510, and/or elsewhere in the MJGS 100.

As further shown in FIG. 8 for at least one implementation of the present disclosure, a sixth operation (6^{th} Op) 8006 may include the GLE 204 communicating, to a notification engine (NE) 404 instantiated by the UMS 400, one or more of the data obtained via one of or more of the above described 1^{st} through 5th operations 8001-8005. The data so communicated may be retrieved from the PIS data store 210, and/or one or more of the above described data stores and stored by the UMS data store 412, and/or elsewhere in the MJGS 100.

As further shown in FIG. 8 for at least one implementation of the present disclosure, a seventh operation (7^{th} Op) 8007 may include the NE 404 communicating data received from the GLE 204 (via the 6^{th} Op 8006) to the PD 102.

As further shown in FIG. 8 for at least one implementation of the present disclosure, an eighth operation (8^{th} Op) 8008 may include the GJIE 206 receiving a request from the PD 102 and replying thereto regarding outcomes of OCGs and/or jackpots previously played by the given player. Data retrieved pursuant to one or more of 8^{th} OP 8008 may be non-transitorily stored in the PIS data store 210 and/or elsewhere in the MJGS 100.

As further shown in FIG. 8 for at least one implementation of the present disclosure, a ninth operation (9^{th} Op) 8009 may include the GJIE 206 querying for an identification of one or more instances of “n” gaming engines (GE(1-n)) 304(1-n), as to be identified by the OCGAS 300, that are available for play by the PD 102, and data regarding categories thereof (e.g., slots, table games, and the like), and the specific games therein available for play by the PD 102.

As further shown in FIG. 8 for at least one implementation of the present disclosure, a tenth operation (10^{th} Op) 8010 may include the GE(1-n) 304(1-n), in response to 9^{th} Op 8009, communicating the responsive data to the OCGE 208.

As further shown in FIG. 8 for at least one implementation of the present disclosure, an eleventh operation (11^{th} Op) 8011 may include the OCGE 208 further communicating the data provided pursuant to 10^{th} Op 8010 to the GJIE 206.

As further shown in FIG. 8 for at least one implementation of the present disclosure, a twelfth operation (12^{th} Op) 8012 may include the GJIE 206 further communicating such data to the NE 404 and by the NE 404 to the PD 102 (e.g., via the 7^{th} Op 8007). The PD 102 may use such data to populate a lobby of OCGs available for play to the given player associated with the PD 102.

As further shown in FIG. 8 for at least one implementation of the present disclosure, a thirteenth operation (13^{th} Op) 8013 may include the GJIE 206 querying the RE 604 for data regarding one or more rewards that the given player may have received.

As further shown in FIG. 8 for at least one implementation of the present disclosure, a fourteenth operation (14^{th} Op) 8014 may include the RE 604 communicating to the NE 404 and then to the PD 102 (e.g., via the 7^{th} Op 8007), data responsive to the query raised during the 13^{th} Op 8013. Data retrieved pursuant to the 13^{th} Op 8013 may be non-transitorily stored in the UMS 400, the JGS 500, the PD 102, and/or elsewhere in the MJGS 100.

As further shown in FIG. 8 for at least one implementation of the present disclosure, a fifteenth operation (15^{th} Op) 8015 may include the GJIE 206 querying one or more of the JE(1-n)s 504(1-n) for data regarding one or more jackpots available, unavailable, currently being played, or otherwise. The data responsive to such query, as received from the JE(1-n)s 504(1-n) may be communicated to the PD 102 (e.g., via the 8^{th} Op 8008) for use by the PD 102 in configuring screen displays (and the like) for presentation to a player of one or more of an OCG, a lobby, and information regarding multiple jackpots available for play, by the player, in conjunction with a given OCG. Data provided pursuant to the 15^{th} Op 8015 may be non-transitorily stored in one or more of the PD 102, PIS 200, the JGS 500, and/or elsewhere in the MJGS 100.

As further shown in FIG. 8 for at least one implementation of the present disclosure, a sixteenth operation (16^{th} Op) 8016 may include the GJIE 206 querying the BHE 708 (as described hereinbelow and as instantiated by the AMS 700) for past gaming history including, but not limited to, prior OCGs played, prior jackpots, prior wagers therein, and results thereof. Responsive data may be further communicated to the PD 102 (e.g., via the 8^{th} Op 8008). Data provided pursuant to the 16^{th} Op 8016 may be non-transitorily stored in one or more of the PD 102, PIS 200, the AMS 700, and/or elsewhere in the MJGS 100.

As further shown in FIG. 8 for at least one implementation of the present disclosure, a seventeenth operation (17^{th} Op) 8017 may include the OCGE 208 communicating, to the SE 406, a request to validate a user session. When validated, a given session with the PD 102 continues. When not validated, the given session with the PD 102 may be terminated or restarted. A session validation request may occur at any time, may occur randomly, periodically, or otherwise. The initiation, maintenance and termination of sessions with a PD 102 are beyond the scope of the present disclosure and any known or later arising devices, systems, processes, computer engines, computer instructions, or the like may be utilized. Data provided pursuant to the 17^{th} Op 8017 may be non-transitorily stored in one or more of the PIS 200, the UMS 400, and/or elsewhere in the MJGS 100.

As further shown in FIG. 8 for at least one implementation of the present disclosure, an eighteenth operation (18^{th} Op) 8018 may include the OCGE 208 communicating, to the PVE 408, a request to verify a player (as then associated with a given PD 102) and one or more gaming permissions for the player. The player verification and/or permission verification may occur at any time, may occur randomly, periodically, or otherwise. It is to be appreciated that when a player is not verified and/or is not verified as having permission to participate in one or more OCGs and/or in one or more jackpots, participation of the player in the session, the OCGs, and/or the jackpot(s) may be suspended, terminated or otherwise treated by the UMS 400 until any conditions inhibiting participation of the player in the given OCG(s) and/or the given jackpot(s) are resolved. It is to be appreciated that the permissioning of players with respect to one or more OCGs and/or one or more jackpots is beyond the scope of the present disclosure and any known or later arising device, systems, processes, computer engines, computer instructions, or the like may be utilized. Data provided pursuant to the 18^{th} Op 8018 may be non-transitorily stored in one or more of the PIS 200, the UMS 400, and/or elsewhere in the MJGS 100.

As further shown in FIG. 8 for at least one implementation of the present disclosure, a nineteenth operation (19^{th} Op) 8019 may include the OCGE 208 communicating to a cash engine (CE) 606 (as described herein and as instantiated by the OCGJTS 600), a request that includes one or more gameplay related activities, such as getting an update on a given player's credit balance, increasing a player's credit balance, processing a refund, initiating a debit to a player's credit balance, for example as arising from a betting action (e.g., the making of a bet and the amount betted), or other financial related aspects of a multi-game jackpot betting experience to which a given one or more bets may apply. The data responsive to such query, as received from the CE 606, may be communicated to the PD 102 (e.g., via the 8^{th} Op 8008). Data provided pursuant to the 19^{th} Op 8019 may be non-transitorily stored in one or more of the PD 102, PIS 200, the JGS 500, and/or elsewhere in the MJGS 100.

As further shown in FIG. 8 for at least one implementation of the present disclosure, a twentieth operation (20^{th} Op) 8020 may include the PD 102 directly communicating a request, to the JGS 500, for data regarding one or more jackpots. Such request may arise without the PD 102 requesting participation in and/or actively participating in a given OCG. For at least one implementation, data responsive to such jackpot query may be communicated to the PD 102 directly by the JGS 500 or indirectly via the GJIE 206. It is to be appreciated that one or more direct or indirect couplings may be utilized in implementations of the present disclosure to communicate data between the PD and the JGS 500 and/or between other MJGS 100 components.

As further shown in FIG. 8 for at least one implementation of the present disclosure, a twenty-first operation (21^{st} Op) 8021 may include the PD 102 directly communicating a request, to the OCGAS 300, for data regarding one or more OCGs. Such request may arise without the PD 102 requesting participation in and/or actively participating in a given OCG. For at least one implementation, data responsive to such OCG query may be communicated directly to the PD 102 by the OCGAS 300 or indirectly via the OCGE 208, and the GJIE 206. It is to be appreciated that one or more direct or indirect couplings may be utilized in implementations of the present disclosure to communicate data between the PD and the OCGAS 300 and/or between other MJGS 100 components.

As further shown in FIG. 8 for at least one implementation of the present disclosure, a twenty-second (22^{nd}) Operation 8022 may include the PVE 408 communicating with the SE 406. Such communications may include data requesting and/or responsive to a request by the SE 406 to verify a given player using the PVE 408. Such verification may occur at any time, including randomly, periodically, or otherwise during a session in which a given player participates in one or more of an OCG and/or one or more jackpots.

As further shown in FIG. 8 for at least one implementation of the present disclosure, a twenty-third (23^{rd}) Operation 8023 may include the GAE 410 communicating with the SE 406. Such communications may include data requesting and/or response to a request to the SE 406 to authenticate a given player participating in one or more of a given OCG and/or one or more jackpots. Such authentication may occur at any time, including randomly, periodically, or otherwise during a session in which the given player participates in one or more of an OCG and/or one or more jackpots.

As further shown in FIG. 8 for at least one implementation of the present disclosure, a twenty-fourth (24^{th}) Operation 8024 may include the CE 606 communicating with the NE 404 and further to the PD 102. Such communications may include data regarding credits available to a given player, account transactions regarding the given player, and/or other credit based (as opposed to rewards) based transactions arising during participation of the given player in an OCG and/or more jackpots.

As further shown in FIG. 8 for at least one implementation of the present disclosure, a twenty-fifth (25^{th}) Operation 8025 may include the RE 604 communicating with the WLE 704. Such communications may include data regarding rewards granted, redeemed, or otherwise and as provided for ledgering into and/or from a given wallet ledger associated with the given player.

As further shown in FIG. 8 for at least one implementation of the present disclosure, a twenty-sixth (26^{th}) Operation 8026 may include the RE 604 communicating with the RLE 706. Such communications may include data regarding rewards granted, redeemed, or otherwise and as provided for ledgering into and/or from a given rewards ledger associated with the given player.

As further shown in FIG. 8 for at least one implementation of the present disclosure, a twenty-seventh (27^{th}) Operation 8027 may include the CE 606 communicating with the WLE 704. Such communications may include data regarding rewards credits to be credited, debited or otherwise and as provided for ledgering into and/or from a given wallet ledger associated with the given player.

As further shown in FIG. 8 for at least one implementation of the present disclosure, a twenty-eighth (28^{th}) Operation 8028 may include the CE 606 communicating with the RLE 706. Such communications may include data regarding rewards granted, redeemed, or otherwise and as provided for ledgering into and/or from a given rewards ledger associated with the given player.

As further shown in FIG. 8 for at least one implementation of the present disclosure, a twenty-ninth (29^{th}) Operation 8029 may include the CE 606 communicating with the JIE 612. Such communications may include data regarding contributions by a given player to one or more jackpots in which the given player has selected to participate. Such contribution data may be provided in conjunction with a gameplay for an OCG associated with the one or more selected jackpots.

As further shown in FIG. 8 for at least one implementation of the present disclosure, a thirtieth (30^{th}) Operation 8030 may include the CE 606 communicating with the JEE 608. Such communications may include data regarding one or more jackpot transactions for the one or more jackpots in which a given player has selected to participate at a given time.

As further shown in FIG. 8 for at least one implementation of the present disclosure, a thirty-first (31^{st}) Operation 8031 may include the JEE 608 communicating with the TQE 610. Such communications may include data regarding one or more jackpot transactions for the one or more jackpots in which a given player has selected to participate at a given time.

As further shown in FIG. 8 for at least one implementation of the present disclosure, a thirty-second operation (32^{nd} Op) 8032 may include the TQE 610 communicating with the JIE 612. Such communications may include data regarding one or more jackpot transactions for the one or more jackpots in which a given player has selected to participate at a given time.

As further shown in FIG. 8 for at least one implementation of the present disclosure, a thirty-third operation (33^{rd} Op) 8033 may include the CE 606 communicating with the JME 614. Such communications may include data regarding one or more jackpot transactions for the one or more jackpots in which a given player has selected to participate at a given time.

As further shown in FIG. 8 for at least one implementation of the present disclosure, a thirty-fourth operation (34^{th} Op) 8034 may include the JME 614 communicating with the WLE 704. Such communications may include data regarding one or more jackpot transactions for the one or more jackpots in which a given player has selected to participate at a given time.

As further shown in FIG. 8 for at least one implementation of the present disclosure, a thirty-fifth operation (35^{th} Op) 8035 may include the JIE 612 communicating with the JME 614. Such communications may include data regarding one or more jackpot transactions for the one or more jackpots in which a given player has selected to participate at a given time. For at least one implementation, the data may pertain to one or more jackpot transactions for a marketing jackpot.

As further shown in FIG. 8 for at least one implementation of the present disclosure, a thirty-sixth operation (36^{th} Op) 8036 may include the JIE 612 communicating with the JGS 500. Such communications may include data regarding one or more jackpot transactions for the one or more jackpots in which a given player has selected to participate at a given time with non-limiting examples including data regarding bets placed, requests for jackpots, player contributions to one or more jackpots, and the like.

As further shown in FIG. 8 for at least one implementation of the present disclosure, a thirty-seventh operation (37^{th} Op) 8037 may include the JIE 612 communicating with the WLE 704. Such communications may include data regarding credits to be awarded to a given players wallet ledger in view of one or more jackpots the given player has won during a given gameplay of a given OCG.

It is to be appreciated that one or more of the above first through thirty-seventh operations described herein may occur singularly, in parallel, in the above described sequence, in another sequence, or otherwise. One or more and/or additional and/or alternative operations may be performed in accordance with an implementation of the present disclosure. Couplings for facilitating such one or more other operations may be provided. For at least one implementation, such couplings and/or operations (not shown) may include those for populating and updating leader boards for one or more OCGs and/or one or more jackpots associated with the one or more OCGS. For at least one implementation, such couplings and/or operations (not shown) may include generating marketing and/or promotional data for output to one or more PDs 102.

Accordingly, it is to be appreciated that the MJGS 100 and the operations performed by the components thereof, provide devices, systems and processes by which multiple jackpots can be associated with one or more selected OCGs, from a plurality of OCGs available for participation therein by a given player at a given time and at a given location. For at least one implementation, ten (10) or more jackpots may be associated with the selected OCG and jackpot results thereof separately and independently determined, tracked, recorded and/otherwise processed while maintaining an MJGS 100 which is robust (in terms of data integrity) and provides communicative separations between PDs 102, OCGASs 300, and AMS 700 and other backend components and functions of the MJGS 100.

The operations identified herein are provided herein for illustrative purposes, are not intended to be limiting, and may be performed (if at all) in any order, sequence, combination, permutation, or otherwise as may be applicable to a given implementation of the present disclosure.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A system, facilitating user participation in multi-jackpot games, comprising:
a player device comprising:
a player device processor;
a player device user interface including a display element; and
wherein a given player is currently associated with the player device;
a non-transitory player device data store non-transitorily storing:
first computer instructions which, when executed by the player device processor, instantiate a lobby engine that configures the player device to perform lobby operations comprising:
receiving a first identification of at least two available online casino games (OCGs) for the given player;
receiving a second identification of at least two available jackpots; and
presenting to the given player, via the display element, the at least two available OCGs and the at least two available jackpots;
a player interface service (PIS), coupled to the player device, facilitating participation by the given player in:
a given selected OCG;
wherein the given selected OCG is determined based on a selection, received from the given player and via the player device, of one of the at least two available OCGs; and
at least one selected jackpot;
wherein the at least one selected jackpots is determined based on a selection, received from the player device, of at least one of the at least two available jackpots; and
a jackpot gamification service (JGS) coupled to the player device and the PIS; and
wherein the JGS is configured to instantiate respective gaming engines for the at least one selected jackpot.

2. The system of claim 1,
wherein the lobby operations further comprise:
determining a current location of the player device;
reporting the current location to the PIS;
receiving from the PIS a third identification of at least two location specific OCGs available to the given player;
wherein the PIS generates the third identification of at least two location specific OCGs available to the given player based on the current location of the player device; and
receiving from the PIS a fourth identification of at least two location specific jackpots available to the given player; and
wherein the PIS generates the fourth identification of the at least two location specific jackpots available to the given player based on the current location of the player device.

3. The system of claim 1,
wherein the lobby operations further comprise:
determining a current time for the player device;
reporting the current time to the PIS;
receiving from the PIS a second identification of at least two time specific OCGs available to the player device; and
receiving from the PIS a second identification of the at least two time specific jackpots available to the player device.

4. The system of claim 1,
wherein the lobby operations further comprise:
querying an online casino gaming aggregator service for an identification of at least two OCGs available to the player device based on at least one of a current time and a current location of the player device.

5. The system of claim 1,
wherein the lobby operations further comprise:
receiving gameplay data, for the given player, from an account management system (AMS);
communicating the gameplay data to the PIS; and
wherein the first identification of at least two available online casino games (OCGs) for the given player is determined, by the PIS, based on the gameplay data for the given player.

6. The system of claim 1,
wherein the presenting of the at least two available OCGs and the at least two available jackpots to the given player further comprises:
generating, on a graphical user interface (GUI) instantiated by the player device user interface, one or more windows including:
an informational window providing data regarding given player participation options in the at least two available online casino games and the at least two available jackpots;
an OCG window presenting the at least two available online casino games; and
a jackpots window presenting the at least two available jackpots.

7. The system of claim 1,
wherein the non-transitory player device data store further non-transitorily stores:
second computer instructions which, when executed by the player device processor, instantiate a player device OCG engine (PDOCGE) that configures the player device to perform OCG operations (OCGOps) comprising:
receiving the selection, by the given player, of the given selected OCG;
launching an OCG module for the given selected OCG; and
communicating gameplay data, for the given selected OCG, with an online casino gaming aggregator service (OCGAS).

8. The system of claim 7,
wherein the non-transitory player device data store further non-transitorily stores:
third computer instructions which, when executed by the player device processor, instantiate player device multi-jackpot gaming engine (PDMJGE) that configures the player device to perform multi-jackpot gaming operations (MJGOps) comprising:
launch operations including:
querying a jackpot data service (JDS) for the second identification, for the at least two available OCGs, of at least two available jackpots; and
subscribing to a message stream providing data regarding one or more of the at least one selected jackpot.

9. The system of claim 8,
wherein the launch operations further include:
activating a bubble module (BubbleM) that configures the player device to generate one or more graphical user interface (GUI) elements that signal to the given player that at least one of the at least two available jackpots is:
available for selection by the given player;
the at least one selected jackpot; or
an unavailable jackpot.

10. The system of claim 9,
wherein the BubbleM further signals to the given player that the at least one selected jackpot is an opted-in jackpot in which the given player participates by default.

11. The system of claim 10,
wherein a jackpot specific wager is not paid in order for the given player to participate in the opted-in jackpot.

12. The system of claim 9,
wherein the BubbleM further signals to the given player and with respect to at least one of the at least two available jackpots:
a selection status;
a reward amount; and
a current wager amount.

13. The system of claim 9,
wherein the one or more GUI elements generated by the BubbleM include a collection of at least two overlay buttons, including a separate overlay button for each of the at least two available jackpots.

14. The system of claim 13,
wherein at least one of the collection of at least two overlay buttons floats over an actionable item presented on the display element of the player device.

15. The system of claim 13,
wherein the collection of at least two overlays further includes a total jackpots overlay button.

16. The system of claim 15,
wherein the total jackpots overlay button includes:
a first field indicating a number of selected jackpots in which the given player is currently participating;
a second field indicating a participation wager for the at least one selected jackpot; and
a third field providing a graphical image that is uniquely associated with the total jackpots overlay button.

17. The system of claim 16,
wherein, upon a selection by the given player of the total jackpots overlay button, the BubbleM generates a second GUI element identifying at least two of the at least two available jackpots and the at least one selected jackpot.

18. The system of claim 17,
wherein the second GUI element is:
presented, by the display element, at least one of horizontally or vertically and across at least a portion of the display element; and
super-imposed upon the at least two OCGs presented on the display element.

19. The system of claim 1,
wherein the lobby operations further comprise:
generating a jackpot buttons bar including two or more jackpot buttons; and
presenting the jackpot buttons bar on the display element;
wherein the jackpots button bar respectively identifies, in a given one of the two or more jackpot buttons, the at least two available jackpots and the at least one selected jackpot.

20. The system of claim 19,
wherein the least two available jackpots and the at least one selected jackpot are presented, in the jackpots button bar, as separate buttons that respectively identify a selection status, a reward amount, and a current wager amount.
